(19) United States
(12) Patent Application Publication
(10) Pub. No.: US 2020/0294170 A1
(43) Pub. Date: Sep. 17, 2020

(54) INFORMATION SETTING APPARATUS AND INFORMATION SETTING METHOD

(71) Applicant: FUJITSU LIMITED, Kawasaki-shi (JP)

(72) Inventor: Hiroyuki YAMASHIMA, Kawasaki (JP)

(73) Assignee: FUJITSU LIMITED, Kawasaki-shi (JP)

(21) Appl. No.: 16/801,419

(22) Filed: Feb. 26, 2020

(30) Foreign Application Priority Data
Mar. 12, 2019 (JP) 2019-045298

(51) Int. Cl. G06Q 50/26; H04L 29/08

(52) U.S. Cl. CPC G06Q 50/265; H04L 67/306

(57) ABSTRACT

An information setting apparatus includes a memory and a processor. The processor configured to: create a template and assistance information based on setting information indicating disclosure agreements and refusals of each item set by other users who have completed settings for information disclosure to a first service, the template having a disclosure agreement or refusal of each of items for the first service set in advance, the assistance information giving assistance for selecting a disclosure agreement or refusal of each of the items, and output the created template and the created assistance information.

### CROSS-REFERENCE TO RELATED APPLICATION

This application is based upon and claims the benefit of priority of the prior Japanese Patent Application No. 2019-45298, filed on Mar. 12, 2019, the entire contents of which are incorporated herein by reference.

### FIELD

The embodiments discussed herein relate to an information setting apparatus and an information setting method.

### BACKGROUND

Heretofore, there has been a mechanism called personal data store (PDS) with which individuals store and manage their own data on their own will. Also, there has been services which use data (personal information) stored and managed with PDS to make proposals, notifications, advertisements, and others suitable to users. A user, a person who discloses information, is allowed to set an agreement or refusal to disclose personal information to an information user who is a provider of a service.

As the related art, there is a technique of: returning, to a terminal device, a collection request to collect information targeted by a use request from an information apparatus, and transmit the collected information to a predetermined destination; and storing into a database the information that the terminal device has collected from the information apparatus and transmitted to the predetermined destination after removing predetermined unauthorized information from the collected information. There is another technique of centrally managing property information of customers, and performing the followings for each service: presenting items of the property information that a service provider may use for the service; receiving an operation for a permission to use the items of the property information to be used for the service; and allowing the service provider to use only the permitted items.

The related art is disclosed, for example, in Japanese Laid-open Patent Publication Nos. 2016-152024 and 2015-176263.

### SUMMARY

According to an aspect of the embodiments, an information setting apparatus includes a memory; and a processor, coupled to the memory, configured to: create a template and assistance information based on setting information indicating disclosure agreements and refusals of each item set by other users who have completed settings for information disclosure to a first service, the template having a disclosure agreement or refusal of each of items for the first service set in advance, the assistance information giving assistance for selecting a disclosure agreement or refusal of each of the items, and output the created template and the created assistance information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a discloser information setting method according to an embodiment;

FIG. 2 is an explanatory diagram illustrating a system configuration example of a disclosure information setting system;

FIG. 3 is a block diagram illustrating a hardware configuration example of an information processing apparatus;

FIG. 4 is a block diagram illustrating a hardware configuration example of a terminal device;

FIG. 5 is an explanatory diagram illustrating an example of stored data in a service information DB;

FIG. 6 is an explanatory diagram illustrating an example of stored data in a user information DB;

FIG. 7 is an explanatory diagram illustrating an example of stored data in an item information DB;

FIG. 8 is an explanatory diagram illustrating an example of stored data in a disclosure agreement information DB;

FIG. 9 is a block diagram illustrating a functional configuration example of the information processing apparatus;

FIG. 10 is an explanatory diagram illustrating a first identification processing example of identifying a user group which has an information disclosure setting tendency similar to that of a target user;

FIG. 11 is an explanatory diagram illustrating a second identification processing example of identifying a user group which has an information disclosure setting tendency similar to that of a target user;

FIG. 12 is an explanatory diagram illustrating an example of stored data in a time-series information DB;

FIG. 13 is an explanatory diagram illustrating a specific example of a template with additional information added (No. 1);

FIG. 14 is an explanatory diagram illustrating a specific example of a template with additional information added (No. 2);

FIGS. 15A and 15B are explanatory diagrams illustrating screen examples of a disclosure agreement operation screen (No. 1);

FIGS. 16A and 16B are explanatory diagrams illustrating screen examples of the disclosure agreement operation screen (No. 2);

FIG. 17 is an explanatory diagram illustrating a screen example of the disclosure agreement operation screen (No. 3);

FIG. 18 is an explanatory diagram illustrating a screen example of the disclosure agreement operation screen (No. 4);

FIG. 19 is an explanatory diagram illustrating a screen example of the disclosure agreement operation screen (No. 5);

FIG. 20 is an explanatory diagram illustrating a screen example of the disclosure agreement operation screen (No. 6);

FIG. 21 is a flowchart illustrating an example of a processing procedure for disclosure information setting in the information processing apparatus;

FIG. 22 presents a flowchart of an example of a specific processing procedure for template creation processing according to a template type “same sex x same generation” and an additional information type “time-series information” (No. 1);

FIG. 23 presents the flowchart of the example of the specific processing procedure for the template creation processing according to the template type “same sex x same generation” and the additional information type “time-series information” (No. 2);

FIG. 24 is a flowchart illustrating an example of an update processing procedure of the time-series information DB;

FIG. 25 presents a flowchart illustrating an example of a specific processing procedure for template creation processing according to a template type “item-related information” and an additional information type “item-related information” (No. 1);FI

FIG. 26 presents the flowchart illustrating the example of the specific processing procedure for the template creation processing according to the template type “item-related information” and the additional information type “item-related information” (No. 2);

FIG. 27 presents a flowchart illustrating an example of a specific processing procedure for first template creation processing according to a template type “clustering” and an additional information type “clustering agreement selection probability” (No. 1);

FIG. 28 presents the flowchart illustrating the example of the specific processing procedure for the first template creation processing according to the template type “clustering” and the additional information type “clustering agreement selection probability” (No. 2);

FIG. 29 presents a flowchart illustrating an example of a specific processing procedure for second template creation processing according to the template type “clustering” and the additional information type “clustering agreement selection probability” (No. 1);

FIG. 30 presents the flowchart illustrating the example of the specific processing procedure for the second template creation processing according to the template type “clustering” and the additional information type “clustering agreement selection probability” (No. 2); and

FIG. 31 is a flowchart illustrating an example of a presentation processing procedure in the terminal device.

### DESCRIPTION OF EMBODIMENTS

The aforementioned related art has a problem that it takes time and effort to set agreements or refusals to disclose the personal information of the user (personal data) to the information user.

Hereinafter, embodiments of an information setting apparatus, an information setting program, and an information setting method according to the disclosure are described in detail with reference to the drawings.

### Embodiments

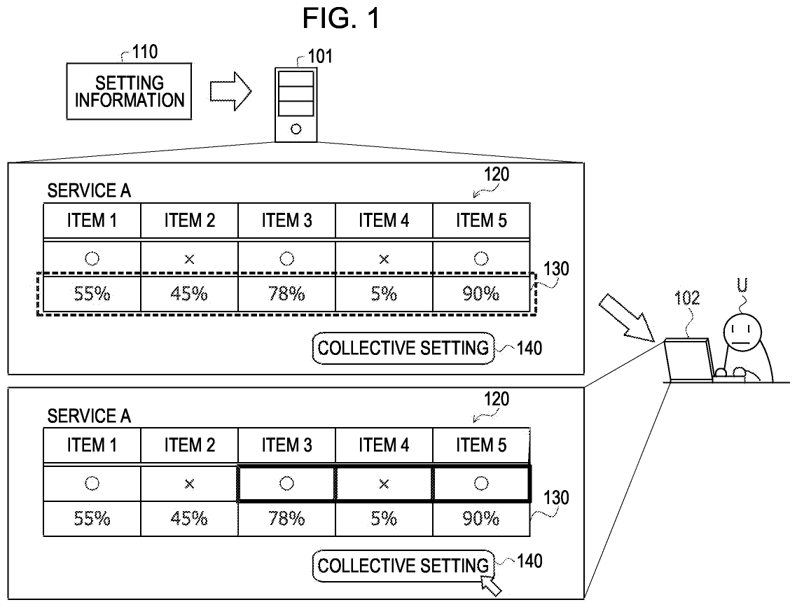

FIG. 1 is an explanatory diagram illustrating an example of a discloser information setting method according to an embodiment. In FIG. 1, an information processing apparatus 101 is a computer that gives assistance for an operation of setting an agreement or refusal to disclose information. The information to be disclosed is information on a user, a person who discloses information, and is, for example, personal information (personal data) of the user stored and managed with PDS.

The user (person who discloses information) is allowed to set an agreement or refusal to disclose each of items of the personal information to each service provided by an information user (for example, services using PDS). As such items, there are various items such for example as name, age, sex, address, family members, schedule information, location information, and purchase information. As such services, there are services of analyzing the information disclosed by the user and thereby making proposals, notifications, advertisements, and so on suitable to the user.

Here, some items are common to services, but it is often the case that services use different items. For this reason, the user has to set an agreement or refusal to disclose each item of the personal information to each of services desired to be used. However, an increase in data stored and managed as the personal information leads to an increase in the number of items that each require a disclosure agreement, which accordingly increases the burden of carrying out operations of setting disclosure agreements or refusals.

In this regard, one possible approach on an opportunity for making settings for information disclosure to a certain service is to present, to a user, a recommended template created based on the choices set by other users in the past (a template in which a disclosure agreement or refusal is set in advance for each item). The template is data serving as a preset format for creating data on a computer. However, the user may have no way of judging whether it is all right to follow the presented template, and may not use the template effectively.

To address this, the present embodiment is described for a disclosure information setting method of making it easy for a user (information provider) who desires to use a service provided by an information user to set agreements and refusals to disclose information. Hereinafter, a processing example of an information processing apparatus 101 is described.

(1) In order for a first user to make settings for information disclosure to a first service, the information processing apparatus 101 fetches setting information indicating disclosure agreements and refusals of each item set by other users who have already completed the settings for information disclosure to the first service. Here, the first user is a user who will use the first service (person who discloses information). The other users are users who have already set a disclosure agreement or refusal of each of the items of the personal information to the first service, and are users who are using the first service, for example.

The example of FIG. 1 is described on the assumption that in order for a user U to make settings for information disclosure to a service A, fetched is setting information 110 which indicates a disclosure agreement or refusal of each of items 1 to 5 set by each of other users who have already completed the settings for information disclosure to the service A.

(2) The information processing apparatus 101 creates, based on the fetched setting information, a template in which a disclosure agreement or refusal of each of the items for the first service is set in advance and assistance information that gives assistance for selecting a disclosure agreement or refusal of each of the items. Here, the template is a recommendation template indicating a recommendation to agree or refuse to disclose each of the items for the first service.

The recommendation to agree or refuse to disclose each of the items is set based on past tendencies of third persons (statistical value). The assistance information is intended to make it easy to set a disclosure agreement or refusal of each of the items, and includes, for example, information (such as statistical information) indicating the grounds for recommending the disclosure agreement or refusal, information that enables settings for multiple items to be made by carrying out a single setting operation, and so forth.

In the example of FIG. 1, it is assumed that a template 120 is created in which a disclosure agreement or refusal of each of the items 1 to 5 for the service A is set in advance. In addition, it is assumed that agreement selection probability information 130 and collective setting information 140 are created as the assistance information that assists the user U to select a disclosure agreement or refusal of each of the items 1 to 5 for the service A.

The agreement selection probability information 130 indicates an agreement selection probability of each of the items 1 to 5 for the service A. The agreement selection probability of each item is statistical information indicating a percentage of other users who have set a disclosure agreement of the item among other users who have already completed the settings for information disclosure to the service A. In the template 120, “∘ (disclosure agreement)” is set for each item with an agreement selection probability of 50% or more, and “× (disclosure refusal)” is set for each item with an agreement selection probability of less than 50%.

The collective setting information 140 is information that enables the user to make settings for multiple items by carrying out a single setting operation. Here, the collective setting information 140 is information that enables disclosure agreements to be set collectively for items with an agreement selection probability of 75% or more among the items 1 to 5 for the service A, and enables disclosure refusals to be set collectively for items with an agreement selection probability of less than 25% among the items 1 to 5 for the service A.

(3) The information processing apparatus 101 outputs the created template and the created assistance information. For instance, the information processing apparatus 101 outputs, as a template in which a disclosure agreement or refusal of each of the items for the service A is set in advance, the template that additionally includes the assistance information for selecting a disclosure agreement or refusal of each of the items.

In the example of FIG. 1, it is assumed that the template 120 to which the agreement selection probability information 130 and the collective setting information 140 are added is outputted from the information processing apparatus 101 to a terminal device 102 used by the user U. In this case, the user U is enabled to set a disclosure agreement or refusal of each of the items 1 to 5 for the service A on the terminal device 102 by using the template 120.

In the template 120, a disclosure agreement or refusal set in advance for each of the items 1 to 5 is changeable. Thus, it is possible to use the choice set in the template 120 without changing it for each item determined to follow the template 120, which results in a reduction in the work for the setting operation. In another case, in addition to the template 120, a region may also be provided for inputting a disclosure agreement or refusal of each of the items 1 to 5 for the service A. In this case, the user U is able to input a disclosure agreement or refusal of each of the items 1 to 5 by referring to the template 120.

In this operation, for each of the items 1 to 5, the user U is able to know what percentage of users agree with information disclosure by referring to the agreement selection probability information 130, and judge whether to follow the template 120. For example, for the item 5, the user U may judge that it is all right for him/her to also agree by following the template 120 since 90% of users agree. On the other hand, in the template 120, the item 1 is marked with “∘ (disclosure agreement)”, but the agreement selection probability thereof is 55% only. This suggests that it is better to judge whether to agree after checking the item name and its item data.

It is possible to set disclosure agreements and/or refusals for the items 3, 4, and 5 collectively by selecting the collective setting information 140. Here, among the items 1 to 5 for the service A, disclosure agreements are set for the items 3 and 5 with agreement selection probabilities of 75% or more, while a disclosure refusal is set for the item 4 with an agreement selection probability of less than 25%. The collectively-settable items are displayed in a manner different from a manner in which other items are displayed. Here, for example, the collectively-settable items 3, 4, and 5 are displayed with bold line frames, and are distinguishable from the other items 1 and 2.

In this way, the information processing apparatus 101 makes it easy for a user (information provider) who desires to use the service A provided by the information user to set disclosure agreements and refusals of personal information. In the example of FIG. 1, the template 120 is presented in which a disclosure agreement or refusal of each of the items for the service A is set in advance in a changeable manner. This reduces the work for the setting operation as compared with the case where a disclosure agreement or refusal of each of the items is set from scratch.

The agreement selection probability information 130 and the collective setting information 140 that assist the user to select a disclosure agreement or refusal of each of the items for the service A are presented together with the template 120. This makes it easy to set a disclosure agreement or refusal of each of the items for the service A. For example, the agreement selection probability information 130 allows the user to easily judge whether it is all right to follow the template 120 by referring to the agreement selection probability (statistical information) of each item. The collective setting information 140 enables settings for multiple items to be made by carrying out a single setting operation, which results in a reduction in the work for the setting operation.

System Configuration Example of Disclosure Information Setting System 200

Next, description is provided for a system configuration example of a disclosure information setting system 200 including the information processing apparatus 101 illustrated in FIG. 1. The disclosure information setting system 200 is applied to a system which sets an agreement or refusal to disclose each of items of personal information of each user (person who discloses information) to a service using PDS, for example.

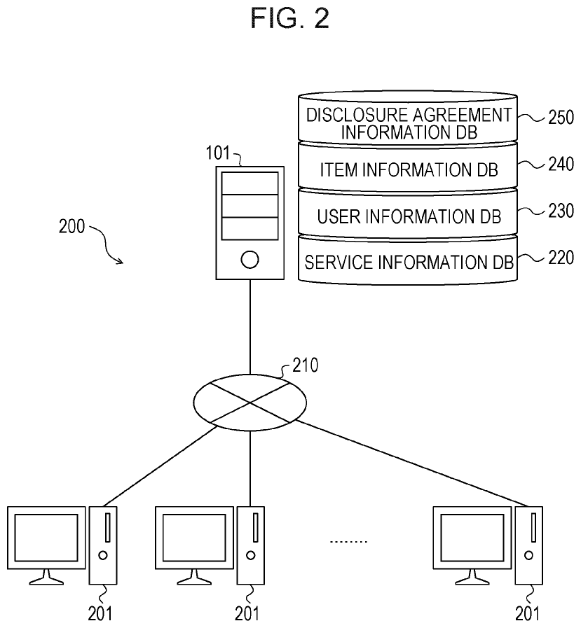

FIG. 2 is an explanatory diagram illustrating the system configuration example of the disclosure information setting system 200. In FIG. 2, the disclosure information setting system 200 includes the information processing apparatus 101 and multiple terminal devices 201. In the disclosure information setting system 200, the information processing apparatus 101 and the multiple terminal devices 201 are coupled to each other via a wired or wireless network 210. The network 210 is, for example, a network such as a local area network (LAN), a wide area network (WAN), or the Internet.

Here, the information processing apparatus 101 includes a service information database (DB) 220, a user information DB 230, an item information DB 240, and a disclosure agreement information DB 250, and assists a user (person who discloses information) to carry out an operation of setting a disclosure agreement or refusal of each of items of personal information. The information processing apparatus 101 is a server for a PDS service platform.

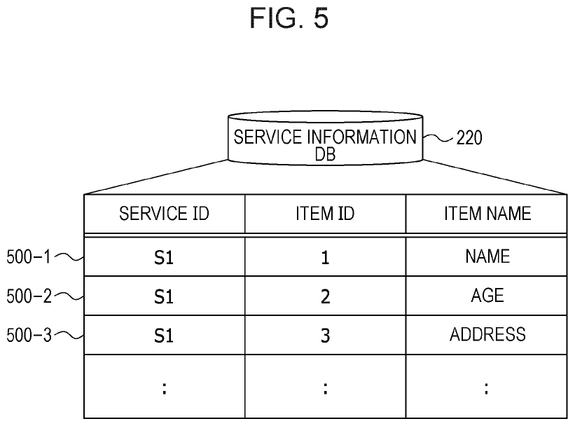

The stored data in these DBs 220, 230, 240, and 250 will be described later with reference to FIGS. 5 to 8.

The terminal devices 201 are computers used by users of the disclosure information setting system 200. The users of the disclosure information setting system 200 are, for example, persons who disclose the personal information and use services provided by information users (persons who disclose information). The information users are, for example, providers of business services using PDS. The terminal devices 201 are, for example, personal computers (PC), tablet PCs, smartphones, and so on. A terminal device 102 illustrated in FIG. 1 corresponds to one of the terminal devices 201, for example.

Hardware Configuration Example of Information Processing Apparatus 101

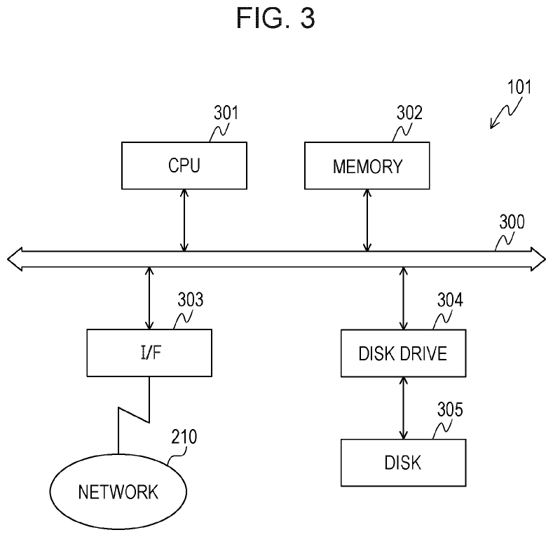

FIG. 3 is a block diagram illustrating a hardware configuration example of the information processing apparatus 101. In FIG. 3, the information processing apparatus 101 includes a central processing unit (CPU) 301, a memory 302, and an interface (I/F) 303, a disk drive 304, and a disk 305. These constituent elements are coupled to one another through a bus 300.

The CPU 301 controls the entirety of the information processing apparatus 101. The CPU 301 may include multiple cores. The memory 302 includes, for example, a read-only memory (ROM), a random-access memory (RAM), a flash ROM, and so on. For instance, the flash ROM and the ROM store various programs, and the RAM is used as a work area of the CPU 301. When loaded by the CPU 301, the programs stored in the memory 302 cause the CPU 301 to execute coded processing.

The I/F 303 is coupled to the network 210 through a communication line, and is coupled to other devices (for example, the terminal devices 201 illustrated in FIG. 2) through the network 210. Then, the I/F 303 functions as an interface between the network 210 and the inside of the apparatus, and controls input and output of data from and to the other devices. As the I/F 303, for example, it is possible to adopt a modem, a LAN adapter, or the like.

The disk drive 304 controls read and write of data from and to the disk 305 under the control of the CPU 301. The disk 305 stores the data written under the control of the disk drive 304. Examples of the disk 305 include a magnetic disk, an optical disk, and so on.

In addition to the above-described constituent elements, the information processing apparatus 101 may include, for example, a solid state drive (SSD), an input device, a display, and so on.

Hardware Configuration Example of Terminal Device 201

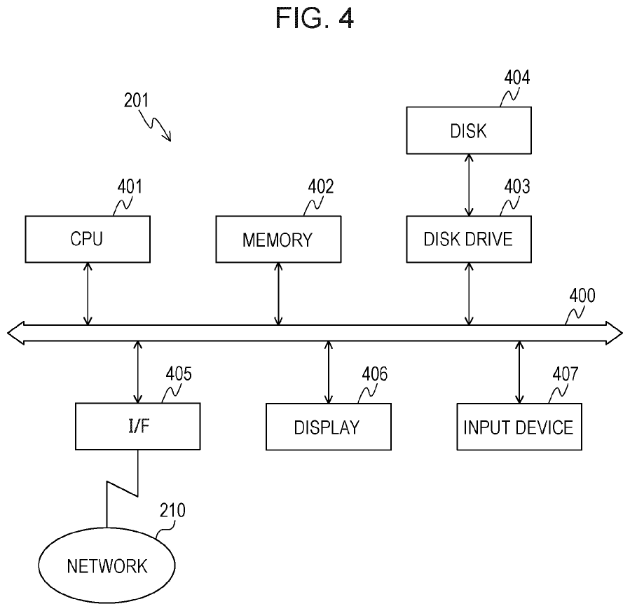

FIG. 4 is a block diagram illustrating a hardware configuration example of the terminal device 201. In FIG. 4, the terminal device 201 includes a CPU 401, a memory 402, a disk drive 403, a disk 404, an I/F 405, a display 406, and an input device 407. These constituent elements are coupled to one another through a bus 400.

The CPU 401 controls the entirety of the terminal device 201. The memory 402 includes, for example, a ROM, a RAM, a flash ROM, and the like. For instance, the flash ROM and the ROM store various programs, and the RAM is used as a work area of the CPU 401. When loaded by the CPU 401, the programs stored in the memory 402 cause the CPU 401 to execute coded processing.

The disk drive 403 controls read and write of data from and to the disk 404 under the control of the CPU 401. The disk 404 stores the data written under the control of the disk drive 403.

The I/F 405 is coupled to the network 210 via a communication line, and is coupled to other apparatuses (for example, the information processing apparatus 101 illustrated in FIG. 2) via the network 210. In addition, the I/F 405 functions as an interface between the network 210 and the inside of the device, and controls input and output of data from and to the other apparatuses.

The display 406 displays not only a cursor, icons, and a toolbox but also data such as documents, images, and functional information. The display 406 is, for example, a liquid crystal display, an organic electro luminescence (EL) display, or the like.

The input device 407 includes keys for inputting letters, numbers, various instructions, and others to input data. The input device 407 may be a keyboard, a mouse, and so on, or may be a touch panel type-input pad, a numeric keypad, and so on. The terminal device 201 does not have to include the disk drive 403 and the disk 404 among the foregoing constituent elements.

Stored Data in DBs 220, 230, 240, and 250

Next, with reference to FIGS. 5 to 8, description is provided for stored data in the DBs 220, 230, 240, and 250 included in the information processing apparatus 101. The DBs 220, 230, 240, and 250 are implemented, for example, by the storage devices such as the memory 302 and the disk 305 illustrated in FIG. 3.

FIG. 5 is an explanatory diagram illustrating an example of stored data in the service information DB 220. In FIG. 5, the service information DB 220 includes fields of SERVICE ID, ITEM ID, and ITEM NAME, and stores records of service information (for example, service information 500-1 to 500-3) by setting information in the fields.

Here, the service ID is an identifier that uniquely identifies a service provided by an information user. The item ID is an identifier that uniquely identifies a personal information item, the information of which is requested to be disclosed in order to use the service. The item name is the name of the item.

For example, the service information 500-1 indicates an item ID “1” and an item name “NAME” of a personal information item, the information of which is requested to be disclosed in order to use a service S1. In the service information in the service information DB 220, a service name may be stored in association with the service ID. The service information may include information that identifies whether or not each item is common to all the services (for example, a common flag).

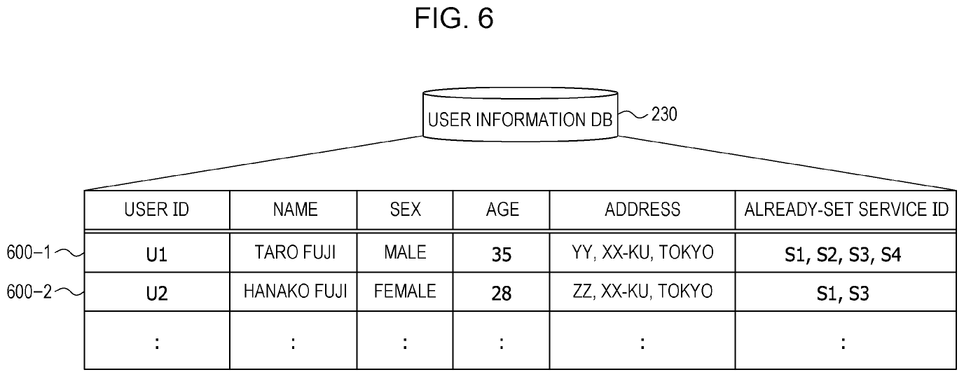

FIG. 6 is an explanatory diagram illustrating an example of stored data in the user information DB 230. In FIG. 6, the user information DB 230 includes fields of USER ID, NAME, SEX, AGE, ADDRESS, and ALREADY-SET SERVICE ID, and stores records of user information (for example, user information 600-1 and 600-2) by setting information in the fields.

Here, the user ID is an identifier that uniquely identifies a user of the disclosure information setting system 200. The name is the name of the user. The sex is the sex of the user. The age is the age of the user. The address is the address of the user. The already-set service ID indicates the service ID of each service to which the user has already completed the settings for information disclosure.

For example, the user information 600-1 indicates information on a user U1 including the name “TARO FUJI”, the sex “MALE”, the age “35”, the address “YY, XX-KU, TOKYO”, and the already-set service IDs “S1, S2, S3, and S4”

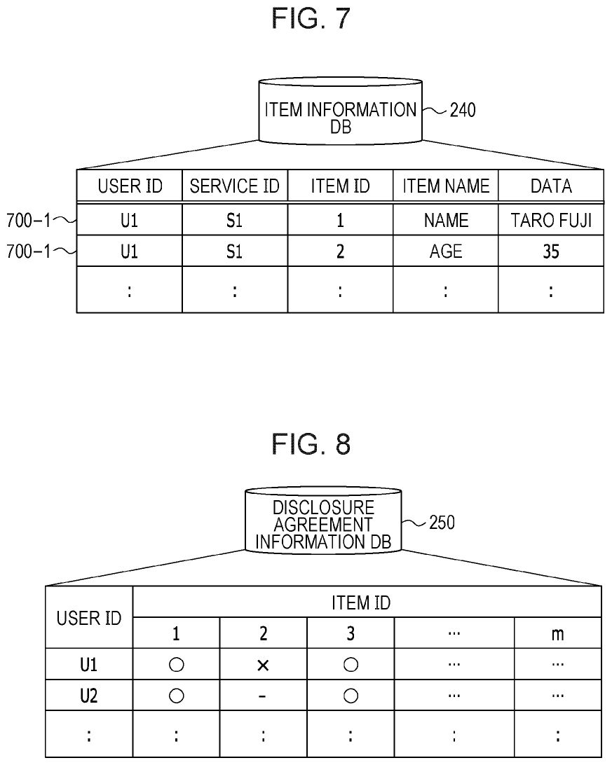

FIG. 7 is an explanatory diagram illustrating an example of stored data in the item information DB 240. In FIG. 7, the item information DB 240 includes fields of USER ID, SERVICE ID, ITEM ID, ITEM NAME, and ITEM DATA, and stores records of item information (for example, item information 700-1 and 700-2) by setting information in the fields.

Here, the user ID is an identifier that uniquely identifies a user of the disclosure information setting system 200. The service ID is an identifier that uniquely identifies a service provided by the information user. The item ID is an identifier that uniquely identifies a personal information item, the information of which is requested to be disclosed in order to use the service. The item name is the name of the item. The item data is factual data of the item (item value).

For example, the item information 700-1 is one piece of personal information of the user U1 registered in PDS, and indicates the item ID “1” for the service S1 and the data “TARO FUJI” of the item with the item name “NAME”. The item information for each user in the item information DB 240 may be stored in the terminal device 201 for the user.

FIG. 8 is an explanatory diagram illustrating an example of stored data in the disclosure agreement information DB 250. In FIG. 8, the disclosure agreement information DB 250 stores disclosure agreement information indicating a disclosure agreement or refusal of each item set by each user. The item is an item for any service provided by the information user.

Here, in the disclosure agreement information, information indicating a disclosure agreement or refusal of each of item IDs (1 to m) is set in association with the item ID (m is a natural number of 2 or more). For example, “∘” indicates a disclosure agreement. Then, “×” indicates a disclosure refusal. Meanwhile, “- (Null)” indicates that a disclosure agreement or refusal is yet to be set.

For example, the disclosure agreement information of the item ID “1” for the user U1 is “∘”. The disclosure agreement information may include the service ID associated with the item ID. The service ID associated with the item ID enables identification of which service is associated with the item with each item ID.

Functional Configuration Example of Information Processing Apparatus 101

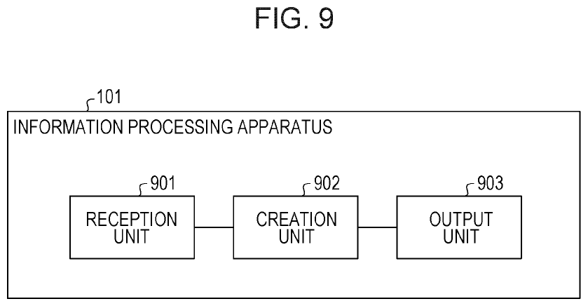

FIG. 9 is a block diagram illustrating a functional configuration example of the information processing apparatus 101. In FIG. 9, the information processing apparatus 101 includes a reception unit 901, a creation unit 902, and an output unit 903. The reception unit 901 to the output unit 903 are functions constituting a control unit, and implement their functions by, for instance, causing the CPU 301 to execute the program stored in the storage device such as the memory 302 or the disk 305 illustrated in FIG. 3 or by using the I/F 303. Processing results of the functional units are stored, for example, in the storage device such as the memory 302 or the disk 305.

In the following description, the multiple services provided by information users are sometimes referred to as “services S1 to Sn” (n is a natural number of 2 or more). Any of the services S1 to Sn is sometimes referred to as a “service S1” (i =1, 2, . . . , n).

The reception unit 901 receives a template creation request. Here, the template creation request is a request which is issued in order to make settings for information disclosure to the service Si, and which requests to create a template in which a disclosure agreement or refusal of each of items for the service Si is set in advance. The template creation request includes, for example, a target user ID, a template type, and an additional information type.

The target user ID is the user ID of a target user. The target user is a user who will make the settings for information disclosure to the service Si. The target user corresponds to the “user U” described with reference to FIG. 1. The template type specifies a template type requested to be created, and designates which type of template is to be created.

Examples of the template types include “target service”, “same sex (same gender)”, “same generation (same age group)”, “same sex×same generation”, “item-related information”, “clustering”, and so on. The template type “target service” is designated in order to request to create a template for a particular service. In this case, the template creation request includes the service ID of the target service (target service ID).

The template type “same sex” is designated in order to request to create a template in which the tendency of users of the same sex as the target user is reflected. The template type “same generation” is designated in order to request to create a template in which the tendency of users of the same generation as the target user is reflected. The template type “same sex x same generation” is designated in order to request to create a template in which the tendency of users of the same sex and same generation as the target user is reflected.

The template type “item-related information” is designated in order to request to create a template in which only items highly related to other items regarding whether the disclosure is agreed are picked out among the items for the service Si. The template type “clustering” is designated in order to request to create a template in which reflected is the information disclosure setting tendency of users who have the tendency similar to that of the target user.

The additional information type specifies a type of additional information to be added to the template, and designates which type of additional information is to be created. The additional information is information that gives assistance for selecting a disclosure agreement or refusal of each item for the service Si. Examples of the additional information types include “agreement selection probability”, “time-series information”, “item-related information”, “clustering agreement selection probability”, and so on.

The additional information type “agreement selection probability” is designated in order to request to create additional information indicating an agreement selection probability of each item. The agreement selection probability indicates a percentage of users who have set a disclosure agreement of the associated item for the service Si among users who have completed the settings for information disclosure to the service Si.

The additional information type “time-series information” is designated in order to request to create additional information indicating a time-series change in the agreement selection probability of each item. The additional information type “item-related information” is designated in order to request to create additional information indicating other items highly related to some items regarding whether the disclosure is agreed.

The additional information type “clustering agreement selection probability” is designated in order to request to create additional information indicating an agreement selection probability of each item in a group of clustered users (cluster). Two or more template types and two or more additional information types may be designated in combination.

For instance, the reception unit 901 receives a template creation request by receiving the template creation request from the terminal device 201. Instead, the reception unit 901 may receive the template creation request from an input operation by the user using an unillustrated input device provided to the information processing apparatus 101.

In order for the target user to make the settings for information disclosure to the service Si, the creation unit 902 fetches the setting information indicating disclosure agreements and refusals of each item set by other users who have already completed the settings for information disclosure to the service Si. Then, the creation unit 902 creates the template and the additional information based on the fetched setting information. Here, the template is a template in which a disclosure agreement or refusal of each of the items for the service Si is set in advance. The additional information is information that gives assistance for selecting a disclosure agreement or refusal of each item for the service Si.

For instance, in response to reception of the template creation request, the creation unit 902 fetches the disclosure agreement information according to the target user ID, the template type, and the additional information type included in the template creation request from the disclosure agreement information DB 250 illustrated in FIG. 8. Then, the creation unit 902 creates a template according to the template type based on the fetched disclosure agreement information. The creation unit 902 creates the additional information according to the additional information type based on the fetched disclosure agreement information.

The creation unit 902 may judge whether the target user has already completed the settings for information disclosure to the service Si. For instance, the creation unit 902 judges whether the target user has already completed the settings for information disclosure to the service Si by referring to the user information DB 230 illustrated in FIG. 6. Each service to which the settings for information disclosure have been already completed is identified from the already-set service ID. Then, the creation unit 902 may create the template and the additional information for the service Si in the case where the target user has not yet completed the settings for information disclosure to the service Si.

Hereinafter, description is provided for a specific processing example of creating a template according to each template type.

Template Type “Target Service”

In the case of the template type “target service”, the creation unit 902 identifies the item IDs associated with the target service ID by referring to the service information DB 220 illustrated in FIG. 5. Thus, the items for the target service are identified. Then, the creation unit 902 fetches the disclosure agreement information associated with the identified item IDs for users other than the target user from the disclosure agreement information DB 250. The target user is identified from the target user ID.

In this way, it is possible to fetch the disclosure agreement information indicating disclosure agreements and refusals of each item set by the other users who have already completed the settings for information disclosure to the target service.

Next, the creation unit 902 calculates the agreement selection probability of each item for the target service based on the fetched disclosure agreement information. Here, as an example, assumed is the case where “100” other users have already completed the settings for information disclosure to the target service and “90” other users have set a disclosure agreement for an item×for the target service. In this case, the agreement selection probability of the item×for the target service is “90% (=90/100×100)”.

Then, the creation unit 902 creates a template in which a disclosure agreement or refusal of each of the items for the target service is set in advance based on the calculated agreement selection probability of the item for the target service. For instance, the creation unit 902 creates a template in which a “disclosure agreement” is set for each item with an agreement selection probability equal to or more than a threshold α, and a “disclosure refusal” is set for each item with an agreement selection probability less than the threshold α. The threshold α may be set to any value, and is set to a value of, for example, about 50%.

In this way, it is possible to create a template in which a disclosure agreement or refusal of each of the items for the target service is set in advance.

Template Type “Same Sex”

In the case of the template type “same sex”, the creation unit 902 identifies the sex of the target user by referring to the user information DB 230. Next, the creation unit 902 identifies other users of the same sex as the target user by referring to the user information DB 230. Then, the creation unit 902 fetches, from the disclosure agreement information DB 250, the disclosure agreement information associated with each item ID for the identified other users of the same sex as the target user.

In this way, for the services S1 to Sn, it is possible to fetch the disclosure agreement information indicating disclosure agreements and refusals of each item set by the other users of the same sex as the target user.

Subsequently, the creation unit 902 calculates the agreement selection probability of each item for each service Si based on the fetched disclosure agreement information. Then, the creation unit 902 creates a template in which a disclosure agreement or refusal of each of the items for each service Si is set in advance based on the calculated agreement selection probability of the item for the service Si.

Thus, for each of the services S1 to Sn, it is possible to create a template in which the information disclosure setting tendency of the users of the same sex as the target user is reflected. In the case where the “target service” and the “same sex” are designated as the template types, for example, the creation unit 902 creates a template for the target service in which the information disclosure setting tendency of the users of the same sex as the target user is reflected.

Template Type “Same Generation”

In the case of the template type “same generation”, the creation unit 902 identifies the generation of the target user by referring to the user information DB 230. The generation is an age group of persons who were born in the same period, and there are generations divided by age and ranging from 10s to 90s, for example. Then, the creation unit 902 identifies other users of the same generation as the target user by referring to the user information DB 230. Subsequently, the creation unit 902 fetches, from the disclosure agreement information DB 250, the disclosure agreement information associated with each item ID for the identified other users of the same generation as the target user.

In this way, for the services S1 to Sn, it is possible to fetch the disclosure agreement information indicating disclosure agreements and refusals of each item set by the other users of the same generation as the target user.

Subsequently, the creation unit 902 calculates the agreement selection probability of each item for each service Si based on the fetched disclosure agreement information. Then, the creation unit 902 creates a template in which a disclosure agreement or refusal of each of the items for each service Si is set in advance based on the calculated agreement selection probability of the item for the service Si.

Thus, for each of the services S1 to Sn, it is possible to create a template in which the information disclosure setting tendency of the users of the same generation as the target user is reflected.

Template Type “Same Sex x Same Generation”

In the case of the template type “same sex x same generation”, the creation unit 902 identifies the sex and generation of the target user by referring to the user information DB 230. Then, the creation unit 902 identifies other users of the same sex and same generation as the target user by referring to the user information DB 230. Subsequently, the creation unit 902 fetches the disclosure agreement information of each item ID for the identified other users of the same sex and same generation as the target user from the disclosure agreement information DB 250.

In this way, for the services S1 to Sn, it is possible to fetch the disclosure agreement information indicating disclosure agreements and refusals of each item set by the other users of the same sex and same generation as the target user.

Subsequently, the creation unit 902 calculates the agreement selection probability of each item for each service Si based on the fetched disclosure agreement information. Then, the creation unit 902 creates a template in which a disclosure agreement or refusal of each of the items for each service Si is set in advance based on the calculated agreement selection probability of the item for the service Si.

Thus, for each of the services S1 to Sn, it is possible to create a template in which the information disclosure setting tendency of the users of the same sex and same generation as the target user is reflected.

Template Type “Item-Related Information”

In the case of the template type “item-related information”, the creation unit 902 determines a relation between items for the services S1 to Sn regarding whether the disclosure is agreed based on the setting information indicating disclosure agreements and refusals of each item set by users who have already completed the settings for information disclosure to the services S1 to Sn. Then, the creation unit 902 selects some of the items for the service Si highly related to other items regarding whether the disclosure is agreed based on the relations determined as a result, and creates the template in which a disclosure agreement or refusal of each of the selected items is set in advance.

For instance, the creation unit 902 identifies related items and a related item count for each item by referring to the disclosure agreement information DB 250. Here, the related item is an item highly related to a concerned item regarding whether the disclosure is agreed. A pair of highly related items have such a relation that once a disclosure agreement or refusal of one of the items is determined, a disclosure agreement or refusal of the other item is also determined. The related item count is the number of related items.

Here, description is provided for an example of identifying related items and the related item count for an item ×. In this case, the creation unit 902 first fetches, from the disclosure agreement information DB 250, the disclosure agreement information of users who have set “∘ (disclosure agreement)” as a disclosure agreement choice of the item ×. Then, the creation unit 902 calculates the agreement selection probability of each of the items different from the item × based on the fetched disclosure agreement information.

After that, the creation unit 902 determines a different item with a calculated agreement selection probability equal to or more than a threshold β as an item related to the item × (first related item). The threshold β may be set to any value, and is set to a value of, for example, about 75%. The creation unit 902 determines a different item with a calculated agreement selection probability less than a threshold γ as an item related to the item × (second related item).

The threshold γ may be set to any value, and is set to a value of, for example, about 25%.

Next, the creation unit 902 fetches, from the disclosure agreement information DB 250, the disclosure agreement information of users who have set “× (disclosure refusal)” as a disclosure agreement choice of the item ×. Then, the creation unit 902 calculates the agreement selection probability of each of the items different from the item × based on the fetched disclosure agreement information. After that, the creation unit 902 determines a different item with a calculated agreement selection probability equal to or more than the threshold β as an item related to the item × (third related item). The creation unit 902 determines a different item with a calculated agreement selection probability less than the threshold γ as an item related to the item × (fourth related item).

Then, the creation unit 902 determines, as the related item count, the total number of the determined related items (the first, second, third, and fourth related items). Instead, the related item count may be the number of related items of at least one type among the first, second, third, and fourth related items. In this way, it is possible to identify the related items highly related to the item × regarding whether the disclosure is agreed, and the related item count.

Then, the creation unit 902 may select p items in descending order of the determined related item count among the items for the service Si, and create a template in which a disclosure agreement or refusal of each of the p items thus selected is set in advance. Here, p may be set to any value, and is set to a value of, for example, about 5 to 10.

Instead, the creation unit 902 may select items having a determined related item count equal to or more than a predetermined number q among the items for the service Si, and create a template in which a disclosure agreement or refusal of each of the items thus selected is set in advance. Also, q may be set to any value, and is set to a value of, for example, about 5 to 10.

In this way, it is possible to create a template in which only items highly related to other items regarding whether the disclosure is agreed are picked out among the items for each service Si.

Template Type “Clustering”

In the case of the template type “clustering”, the creation unit 902 identifies a user group which has an information disclosure setting tendency similar to that of the target user. Then, the creation unit 902 creates a template in which a disclosure agreement or refusal of each item for the target service is set in advance based on the setting information indicating the disclosure agreements and refusals of each of the items for the target service set by the users in the identified user group.

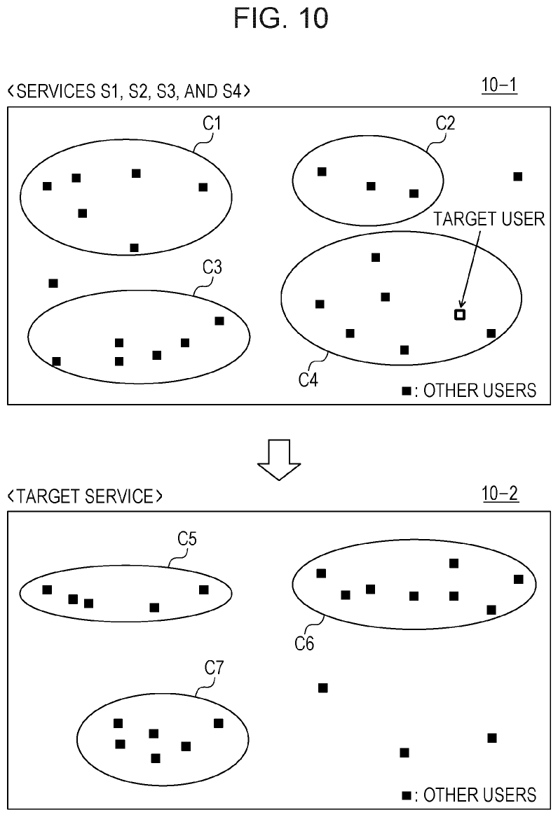

Here, description is provided for identification processing examples of identifying a user group which has an information disclosure setting tendency similar to that of the target user. First of all, a first identification processing example is described by using FIG. 10.

FIG. 10 is an explanatory diagram illustrating the first identification processing example of identifying a user group which has an information disclosure setting tendency similar to that of the target user. The creation unit 902 identifies other users who have completed the settings for information disclosure to all the services to which the target user has completed the settings for information disclosure among the services S1 to Sn.

For instance, the creation unit 902 identifies the already-set service IDs of the target user by referring to the user information DB 230. Then, the creation unit 902 identifies other users whose already-set service IDs include the identified already-set service IDs by referring to the user information DB 230.

In the example of FIG. 10, the already-set service IDs of the target user are “S1, S2, S3, and S4”. In this case, the creation unit 902 identifies other users whose already-set service IDs include “S1, S2, S3, and S4” by referring to the user information DB 230. In this process, the creation unit 902 may identify other users whose already-set service IDs are completely identical to “S1, S2, S3, and S4”.

In this way, it is possible to identify the other users who have completed the settings for information disclosure to the same combination of services as the target user among the services S1 to Sn.

Next, the creation unit 902 identifies a user group which has an information disclosure setting tendency similar to that of the target user based on the setting information indicating the disclosure agreements and refusals of each of the items for the services S1 to Sn set by the target user and the identified other users. For instance, the creation unit 902 performs clustering based on the disclosure agreement information of the items for the services S1 to Sn for the identified other users and the target user by referring to the disclosure agreement information DB 250.

In a more specific example, the creation unit 902 plots each of the identified other users in a multidimensional coordinate system by using, as an element, a disclosure agreement or refusal of each of the items for the services S1 to Sn set by the user concerned. The creation unit 902 plots the target user in the multidimensional coordinate system by using, as an element, a disclosure agreement or refusal of each of the items for the services S1 to Sn set by the target user.

When the total number of items for the services S1 to Sn is m, the coordinates of each point plotted in the multidimensional coordinate system (□ and ▪ in FIG. 10) are determined by the m elements. Each element takes any of “∘ (disclosure agreement)”, “× (disclosure refusal)”, and “- (Null)”.

Then, the creation unit 902 divides the user group containing the identified other users and the target user into clusters (subsets) based on the coordinates of the plotted points, for example. As the clustering technique, any existing technique may be applied. In the example illustrated in upper side 10-1 of FIG. 10, the user group is divided into clusters C1 to C4.

The cluster C4 is a cluster containing the target user among the clusters C1 to C4. Thus, the users belonging to the cluster C4 are identified as a user group which has an information disclosure setting tendency similar to that of the target user.

In this case, for example, the creation unit 902 plots each of the other users in the cluster C4 different from the target user in a multidimensional coordinate system by using, as an element, a disclosure agreement or refusal of each of the items for the target service by referring to the disclosure agreement information DB 250. This plotting process is performed by using only users who have completed the settings for information disclosure to the target service. Then, the creation unit 902 divides the other users in the cluster C4 into clusters based on the coordinates of the plotted points, for example.

In the example illustrated in lower side 10-2 of FIG. 10, the other users are divided into clusters C5 to C7. In this case, the creation unit 902 creates a template for each of the clusters C5 to C7 in which a disclosure agreement or refusal of each item for the target service is set in advance. For instance, the creation unit 902 fetches, from the disclosure agreement information DB 250, the disclosure agreement information of the items for the target service for the users belonging to each of the clusters.

Next, for each of the clusters, the creation unit 902 calculates the agreement selection probability of each of the items for the target service based on the fetched disclosure agreement information. Then, the creation unit 902 creates a template for each of the clusters in which a disclosure agreement or refusal of each of the items for the target service is set in advance based on the calculated agreement selection probability of the item for the target service.

In this way, it is possible to create a template for each of the clusters C5 to C7. That is, it is possible to create a template for each of the clusters C5 to C7 by dividing the user group which has the information disclosure setting tendency similar to that of the target user into the clusters C5 to C7 each containing users similar to each other in the information disclosure setting tendency for the target service. Instead, the creation unit 902 may create a template only for any one of the clusters C5 to C7.

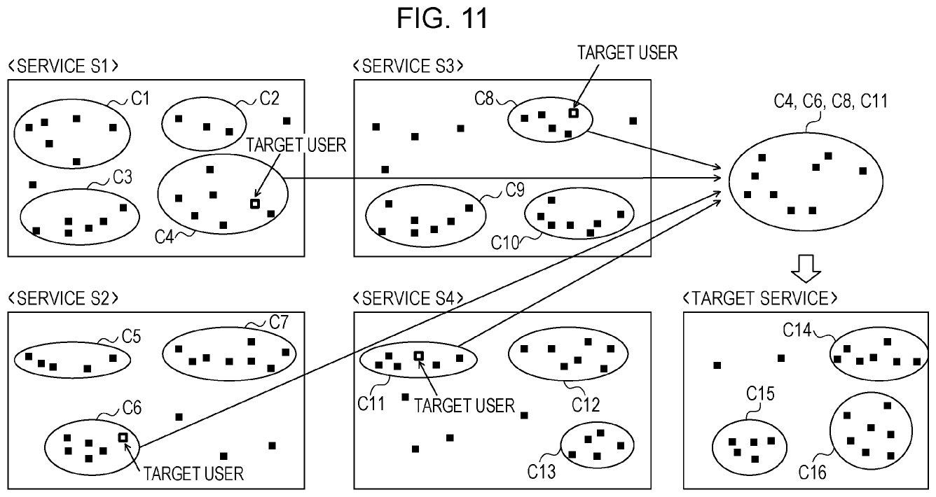

Next, a second identification processing example is described by using FIG. 11.

FIG. 11 is an explanatory diagram illustrating the second identification processing example of identifying a user group which has an information disclosure setting tendency similar to that of the target user. For each service to which the target user has completed the settings for information disclosure among the services S1 to Sn, the creation unit 902 identifies a user group which has an information disclosure setting tendency similar to that of the target user based on the setting information indicating the disclosure agreements and refusals of each item set by the users who have completed the settings for information disclosure to the service.

For instance, the creation unit 902 identifies the already-set service IDs of the target user by referring to the user information DB 230. Then, for each of the identified already-set service IDs, the creation unit 902 identifies other users whose already-set service IDs include the concerned service ID by referring to the user information DB 230.

In the example of FIG. 11, the already-set service IDs of the target user are “S1, S2, S3, and S4”. In this case, for each of the identified already-set service IDs “S1, S2, S3, and S4”, the creation unit 902 identifies other users whose already-set service IDs include the concerned service ID.

Thus, for each of the services to which the target user has completed the settings for information disclosure, it is possible to identify the other users who have completed the settings for information disclosure to the service.

Then, for each of the services S1, S2, S3, and S4, for example, the creation unit 902 performs clustering based on the disclosure agreement information of each of the items for the concerned service S1, S2, S3, or S4 for the identified other users and the target user by referring to the disclosure agreement information DB 250.

In the example of FIG. 11, for the service S1, the users are divided into clusters C1 to C4. The cluster C4 is a cluster containing the target user among the clusters C1 to C4. For the service S2, the users are divided into clusters C5 to C7. The cluster C6 is a cluster containing the target user among the clusters C5 to C7. For the service S3, the users are divided into clusters C8 to C10. The cluster C8 is a cluster containing the target user among the clusters C8 to C10. For the service S4, the users are divided into clusters C11 to C13. The cluster C11 is a cluster containing the target user among the clusters C11 to C13.

Thus, the users belonging to the clusters C4, C6, C8, and C11 are identified as a user group which has the information disclosure setting tendency similar to that of the target user.

In this case, for example, the creation unit 902 plots each of the other users in the clusters C4, C6, C8, and C11 different from the target user in a multidimensional coordinate system by using, as an element, a disclosure agreement or refusal of each of the items for the target service by referring to the disclosure agreement information DB 250. Then, the creation unit 902 divides the other users in the clusters C4, C6, C8, and C11 into clusters based on the coordinates of the plotted points, for example.

In the example illustrated in FIG. 11, the other users belonging to the clusters C4, C6, C8, and C11 are divided into clusters C14 to C16. In this case, the creation unit 902 creates a template for each of the clusters C14 to C16 in which a disclosure agreement or refusal of each of the items for the target service is set in advance.

In this way, it is possible to create a template for each of the clusters C14 to C16. That is, it is possible to create a template for each of the clusters C14 to C16 by dividing the user group which has the information disclosure setting tendency similar to that of the target user into the clusters C14 to C16 each containing users similar to each other in the information disclosure setting tendency for the target service. Instead, the creation unit 902 may create a template only for any one of the clusters C14 to C16.

Returning to FIG. 9, description is provided for a specific processing example of creating additional information according to each additional information type.

Additional Information Type “Agreement Selection Probability”

In the case of the additional information type “agreement selection probability”, the creation unit 902 calculates the agreement selection probability of each of the items for the service Si. Then, the creation unit 902 creates additional information indicating the calculated agreement selection probability of each of the items for a service Si. Here, the service Si may be the target service or may be each of the services S1 to Sn.

That is, the agreement selection probability of each item may be calculated only for the target service designated by the user or may be calculated for all the services S1 to Sn. The disclosure agreement information used to calculate the agreement selection probability may be the disclosure agreement information of all the users, or may be the disclosure agreement information of users of the same sex and same generation as the target user.

In addition, irrespective of the additional information type, the creation unit 902 may also create additional information that enables the user to make the settings for multiple items by carrying out a single setting operation base on the calculated agreement selection probabilities of the respective items for the service Si. For example, the creation unit 902 may create additional information that enables disclosure agreements to be set collectively for items each having an agreement selection probability equal to or more than the threshold β among the items for the service Si. The creation unit 902 may create additional information that enables disclosure refusals to be set collectively for items each having an agreement selection probability less than the threshold γ among the items for the service Si.

For example, it is assumed that the threshold β is “β=75%” and the threshold γ is “γ=25%”. In this case, the creation unit 902 creates additional information that enables disclosure agreements and/or refusals to be set collectively for items each having an agreement selection probability equal to or more than the threshold 75% and/or for items each having an agreement selection probability less than the threshold 25% among the items for the service

Si.

Additional Information Type “Time-Series Information”

In the case of the additional information type “time-series information”, the creation unit 902 calculates the agreement selection probability of each of the items for a service Si on a regular or irregular basis. The disclosure agreement information used to calculate the agreement selection probability may be the disclosure agreement information of all the users, or may be the disclosure agreement information of users of the same sex and same generation as the target user.

Then, the creation unit 902 creates additional information indicating a time-series change in the agreement selection probability of each of the items for the service Si within a given period T, based on the agreement selection probability of the item for the service Si calculated on the regular or irregular basis. The given period T may be set to any period, and is set to a period such for example as the most recent one week or the most recent one month.

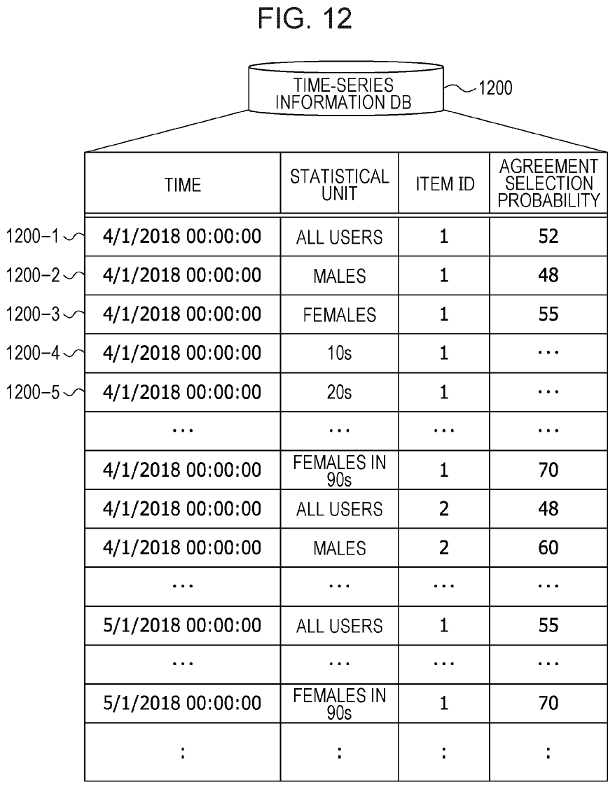

The calculated agreement selection probability of each of the items for the service Si is stored, for example, in a time-series information DB 1200 as illustrated in FIG. 12. Here, description is provided for stored data in the time-series information DB 1200. The time-series information DB 1200 is implemented by the storage device such as the memory 302 or the disk 305 illustrated in FIG. 3. Here, assumed is the case where the agreement selection probability of each of the items for each of the services S1 to Sn is calculated on a daily basis.

FIG. 12 is an explanatory diagram illustrating an example of the stored data in the time-series information DB 1200. In FIG. 12, the time-series information DB 1200 includes fields of TIME, STATISTICAL UNIT, ITEM ID, and AGREEMENT SELECTION PROBABILITY, and stores records of agreement selection probability information (for example, agreement selection probability information 1200-1 to 1200-5) by setting information in the fields.

Here, the time indicates the date and time when the agreement selection probability of each of the items for the services S1 to Sn was calculated. The statistical unit indicates the disclosure agreement information used to calculate the agreement selection probability. The statistical unit indicates any of all users, males, females, 10s, 20s, . . . , 90s, males in 10s, males in 20s, ..., males in 90s, females in 10s, females in 20s, ..., and females in 90s.

For example, the statistical unit “all users” indicates the disclosure agreement information of all the users. The statistical unit “males” indicates the disclosure agreement information of male users. The statistical unit “females” indicates the disclosure agreement information of female users. The statistical unit “10s” indicates the disclosure agreement information of teen users. The statistical unit “20s” indicates the disclosure agreement information of users in their twenties. The statistical unit “females in 905” indicates the disclosure agreement information of female users in their nineties.

The item ID is an identifier that uniquely identifies each of the items for the services S1 to Sn. The agreement selection probability indicates a percentage of users who have set a disclosure agreement of the associated item for the service Si among users who have completed the settings for information disclosure to the service Si.

For example, the creation unit 902 creates additional information indicating a time-series change in the agreement selection probability of each of the items for the service Si within the given period T by referring to the time-series information DB 1200. The time-series change in the agreement selection probability may be represented, for example, by a line chart or a bar chart.

Additional Information Type “Item-Related Information”

In the case of the additional information type “item-related information”, the creation unit 902 determines a relation between items for multiple services regarding whether the disclosure is agreed based on the setting information indicating the disclosure agreements and refusals of each item set by users who have already completed the settings for information disclosure to the services S1 to Sn. Then, the creation unit 902 may create, based on the relations determined as a result, additional information indicating a disclosure agreement or refusal of each of items highly related to some of the items for the service Si regarding whether the disclosure is agreed.

In this case, the creation unit 902 may create, based on the relations determined as the result, additional information that enables disclosure agreements and refusals to be set collectively for a certain item for the service Si and other items highly related to the certain item regarding whether the disclosure is agreed.

For instance, the creation unit 902 identifies items related to each item by referring to the disclosure agreement information DB 250. Then, for each item for the service Si, the creation unit 902 creates additional information indicating the disclosure agreements and/or refusals of the identified related items. In this case, for each item for the service Si, the creation unit 902 may also create additional information that enables disclosure agreements and/or refusals to be set collectively for the concerned item and the items related to the concerned item.

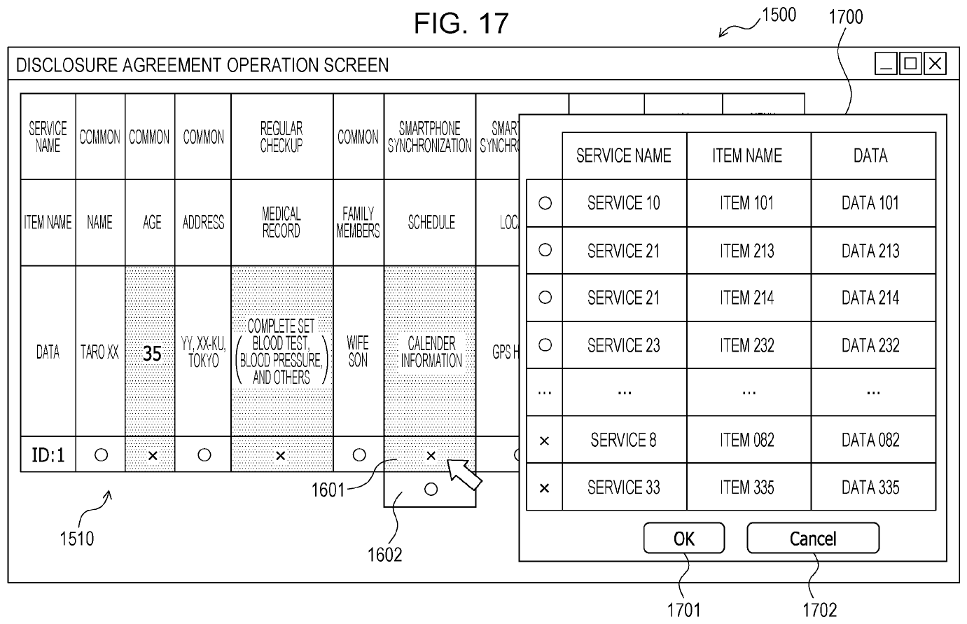

A specific example of the additional information that enables the disclosure agreements and/or refusals to be set collectively for the concerned item for the service Si and the items related to the concerned item will be described later with reference to FIGS. 17 to 20.

Additional Information Type “Clustering Agreement Selection Probability”

In the case of the additional information type “clustering agreement selection probability”, the creation unit 902 calculates the agreement selection probability of each of the items for the target service based on the disclosure agreement information of the user group which has an information disclosure setting tendency similar to that of the target user. The user group which has the information disclosure setting tendency similar to that of the target user contains, for example, the other users belonging to the cluster C4 illustrated in FIG. 10 or the other users belonging to the clusters C4, C6, C8, and C11 illustrated in FIG. 11. Then, the creation unit 902 creates additional information indicating the calculated agreement selection probability of each of the items for the target service.

For each of clusters formed by further clustering the user group which has the information disclosure setting tendency similar to that of the target user, the creation unit 902 calculates the agreement selection probability of each of the items for the target service based on the disclosure agreement information of the users belonging to the concerned cluster. The clusters formed by further clustering the user group which has the information disclosure setting tendency similar to that of the target user are, for example, the clusters C5, C6, and C7 illustrated in FIG. 10 or the clusters C14, C15, and C16 illustrated in FIG. 11. Thus, it is possible to further divide the user group which has the information disclosure setting tendency similar to that of the target user into groups of users similar to each other in the information disclosure setting tendency for the target service and to create statistical information (agreement selection probability) on a divided user group basis.

The output unit 903 outputs the created template and assistance information. The output unit 903 outputs them in a mode of, for example, storing them into the storage device such as the memory 302 or the disk 305, transmitting them to another computer through the I/F 303, or presenting them on an unillustrated display of the information processing apparatus 101.

For instance, the output unit 903 transmits the created template to which the additional information is added to the terminal device 201 which is the request sender of the template creation request. As a result, a disclosure agreement operation screen including the template with additional information added is displayed on the terminal device 201. The disclosure agreement operation screen is an operation screen for the target user to make the settings for information disclosure to the service Si.

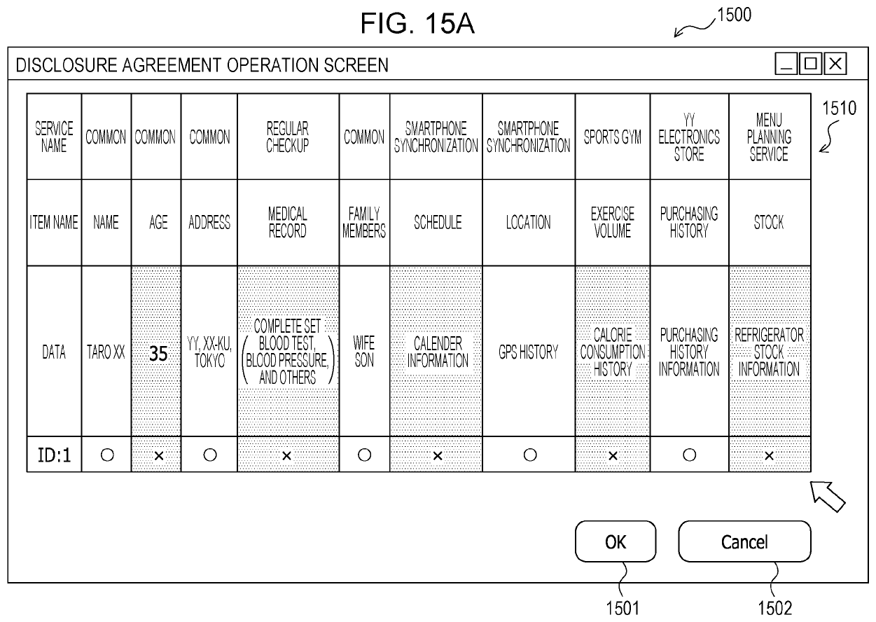

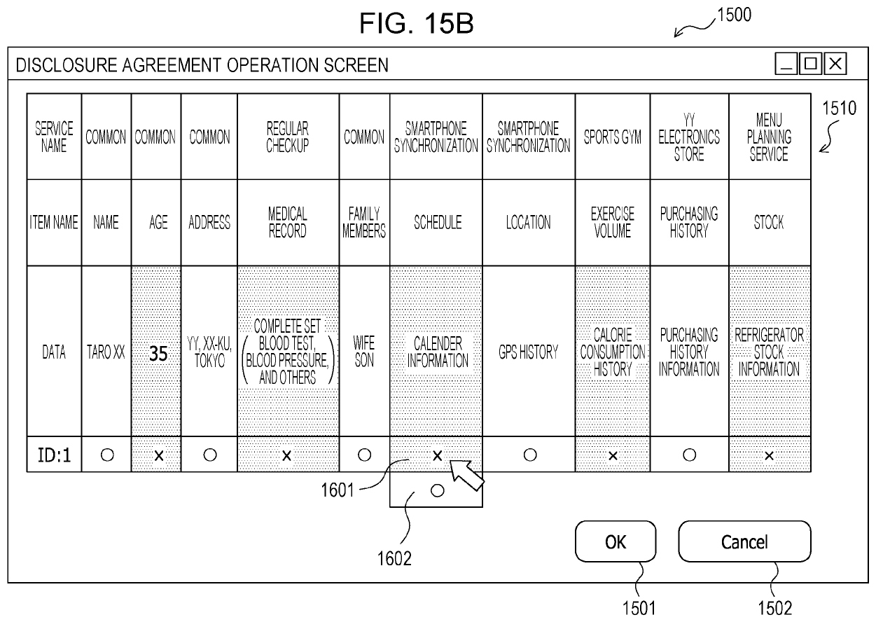

Screen examples of the disclosure agreement operation screen will be described later with reference to FIGS. 15A to 20.

Specific Example of Template with Additional Information Added

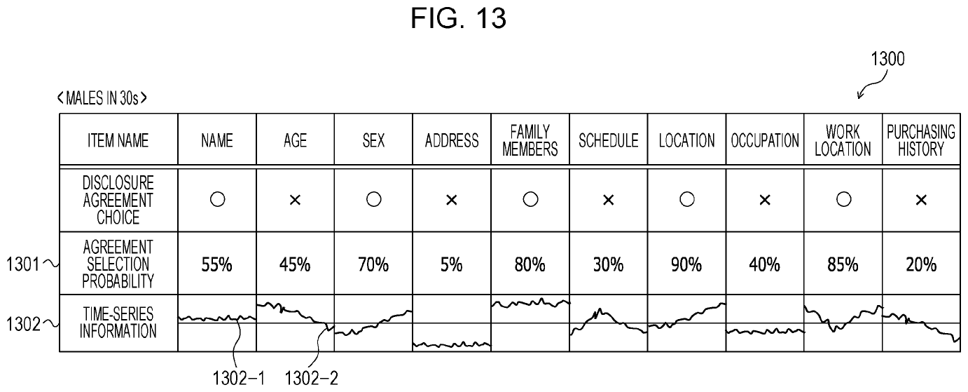

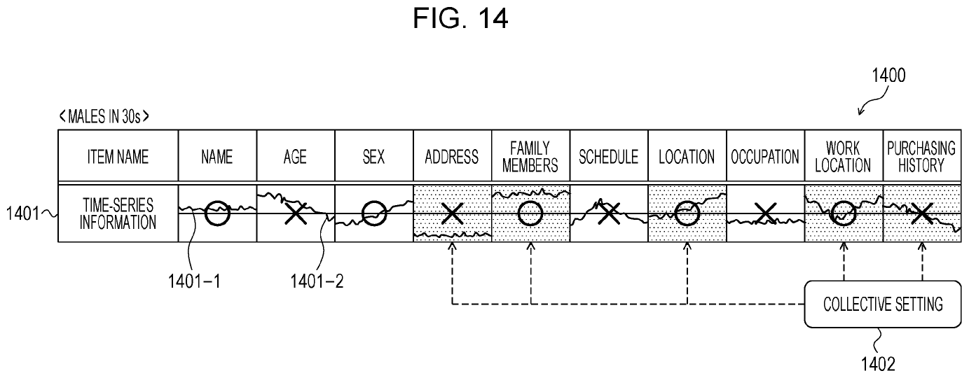

Next, with reference to FIGS. 13 and 14, description is provided for a specific example of a template with additional information added.

FIG. 13 is an explanatory diagram illustrating a specific example of a template additional information added (No. 1). Here, assumed is the case where the template types “target service” and “same sex x same generation” are designated and the additional information types of “agreement selection probability” and “time-series information” are designated. The target user and other users of the same age and same generation are “males in 305”.

In FIG. 13, the template 1300 is a template in which a disclosure agreement or refusal of each of the items for the target service is set in advance. For example, “∘ (disclosure agreement)” is set for the item with the item name “NAME”. Then, “× (disclosure refusal)” is set for the item with the item name “AGE”.

To the template 1300, additional information 1301 and additional information 1302 are added. The additional information 1301 indicates the agreement selection probability of each item for the target service. For example, the agreement selection probability of the item with the item name “NAME” is “55%”. The agreement selection probability of the item with the item name “AGE” is “45%”.

The additional information 1302 indicates a time-series change in the agreement selection probability of each item for the target service within a given period T. For example, a chart 1302-1 is presented as information indicating a time-series change in the agreement selection probability of the item with the item name “NAME”. A chart 1302-2 is presented as information indicating a time-series change in the agreement selection probability of the item with the item name “AGE”. A horizontal line in the cell presenting the chart for each item is a reference line representing an agreement selection probability of “50%”.

When making the settings for information disclosure to the target service, the target user is able to know, by viewing the template 1300, the setting tendency that the users of the same sex and same generation as the target user have in terms of the disclosure agreement and/or refusal of each item for the target service.

By viewing the additional information 1301, the target user is able to know what percentage of other users agree with information disclosure of each of the items for the target service. For example, for the item with the item name “FAMILY MEMBERS”, 80% of the people agree, and therefore the target user may judge that it is all right for him/her to also agree by following the template 1300. On the other hand, in the template 1300, the item with the item name “NAME” is marked with “∘ (disclosure agreement)”, but the agreement selection probability thereof is 55% only. This suggests that it is better to carefully consider whether to agree with the disclosure.

By viewing the additional information 1302, the target user is able to know how the percentage of users agreeing with information disclosure (agreement selection probability) of each of the items for the target service has changed over time. For example, the chart 1302-2 teaches that the percentage of users agreeing with the information disclosure of the item with the item name “AGE” has been decreasing. Thus, the target user may judge that it is better to refuse the information disclosure of the item with the item name “AGE” because the percentage of users agreeing with the information disclosure is currently 45% that is not a high value, and has been decreasing.

FIG. 14 is an explanatory diagram illustrating a specific example of a template with additional information added (No. 2). Here, assumed is the case where the template types “target service” and “same sex x same generation” are designated and the additional information type “time-series information” is designated. The target user and other users of the same age and same generation are “males in 305”.

In FIG. 14, the template 1400 is a template in which a disclosure agreement or refusal of each of the items for the target service is set in advance. For example, “∘ (disclosure agreement)” is set for the item with the item name “NAME”. Then, “× (disclosure refusal)” is set for the item with the item name “AGE”.

To the template 1400, additional information 1401 and additional information 1402 are added. The additional information 1401 indicates a time-series change in the agreement selection probability of each item for the target service within a given period T. For example, a chart 1401-1 is presented as information indicating a time-series change in the agreement selection probability of the item with the item name “NAME”. A chart 1401-2 is presented as information indicating a time-series change in the agreement selection probability of the item with the item name “AGE”.

The additional information 1402 is information that enables the user to make the settings for multiple items by carrying out a single setting operation. Here, the additional information 1402 is information that enables disclosure agreements to be set collectively for items with an agreement selection probability of 75% or more among the items for the target service, and enables disclosure refusals to be set collectively for items with an agreement selection probability of less than 25% among the items for the target service.

When making the settings for information disclosure to the target service, the target user is able to know, by viewing the template 1400, the setting tendency that the users of the same sex and same generation as the target user have in terms of the disclosure agreement and/or refusal of each item for the target service.

By viewing the additional information 1401, the target user is able to know how the percentage of users agreeing with the information disclosure (agreement selection probability) of each of the items for the target service has changed over time. For example, the chart 1401-2 teaches that the percentage of users agreeing with the information disclosure of the item with the item name “AGE” has been decreasing. Thus, the target user may judge that it is better to refuse the information disclosure of the item with the item name “AGE” because the percentage of users agreeing with the information disclosure has been decreasing.

The additional information 1402 enables the user to make the settings for multiple items collectively by carrying out a single setting operation. The background color of multiple items for which the settings will be made collectively by a single setting operation (the background color of the cells presenting the time-series information) is different from a color for the other items, which makes the collectively settable items distinguishable.

For example, when the additional information 1402 is selected, the disclosure agreements and refusals are set collectively for the items with the item names “ADDRESS”, “FAMILY MEMBERS”, “LOCATION”, “WORK LOCATION”, and “PURCHASING HISTORY”. Here, the disclosure agreements are set for the items with the item names “FAMILY MEMBERS”, “LOCATION”, and “WORK LOCATION” because their agreement selection probabilities are 75% or more. On the other hand, the disclosure refusals are set for the items with the item names “ADDRESS” and “PURCHASING HISTORY” because their agreement selection probabilities are less than 25%.

Screen Example of Disclosure Agreement Operation Screen

Next, with reference to FIGS. 15A to 20, description is provided for screen examples of the disclosure agreement operation screen displayed on the display 406 of the terminal device 201. The following description is provided by taking, as an example, a case where a user performs a click operation as an operation of selecting a button or the like displayed on the operation screen.

FIGS. 15A to 20 are explanatory diagrams illustrating the screen examples of the disclosure agreement operation screen. In FIG. 15A, the disclosure agreement operation screen 1500 is an operation screen for the target user to make the settings for information disclosure to the service Si. Here, assumed is the case of making settings for information disclosure to multiple services. Assumed is the case where an item common to all the services is displayed only once. Assumed is the case where the template type “item-related information” is designated and the additional information type “item-related information” is designated.

The disclosure agreement operation screen 1500 includes a template 1510 in which a disclosure agreement or refusal (∘ or ×) of each of the items for the service Si is set in advance. Here, a service name is the name of each service Si. The service name “common” is a service name for an item common to all the services. The item name is the name of a personal information item, the information of which is requested to be disclosed in order to use the service Si.

The item data is factual data of the item, that is, a content of the personal information of the target user. The item data may be omitted from the display. ID is an identifier that uniquely identifies the template 1510. In the disclosure agreement operation screen 1500, cells in each of which a disclosure agreement or refusal (∘ or ×) of each item is set are displayed differently depending on the disclosure agreement or refusal, which makes it easy to distinguish between the disclosure agreement and refusal.

In the disclosure agreement operation screen 1500, when any cell in which a disclosure agreement or refusal is set for the associated item is clicked through an input operation by a user on the input device 407 illustrated in FIG. 4, for example, the alternative choice is displayed in a pull-down tab. In FIG. 15B, as a result of clicking a cell 1601, an alternative choice 1602 is displayed.

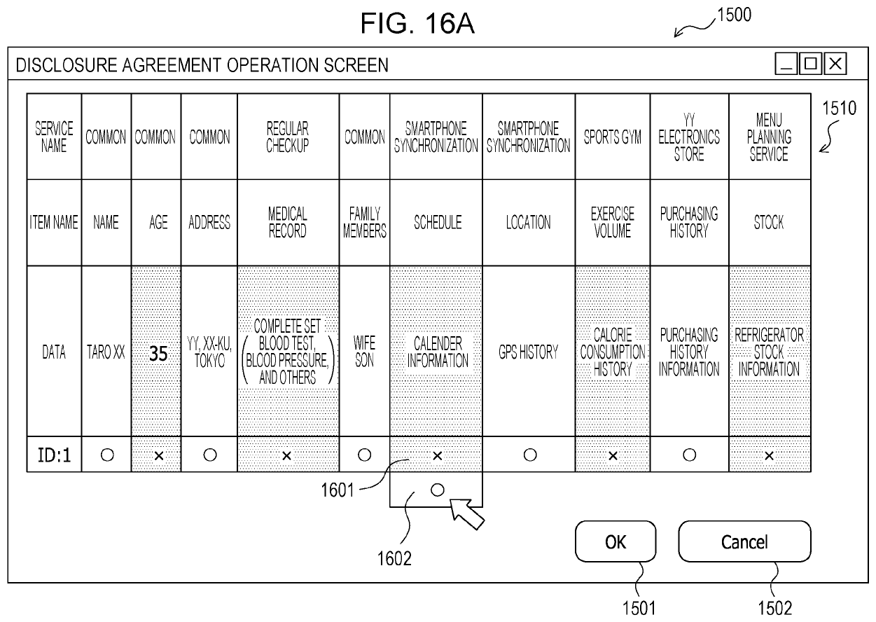

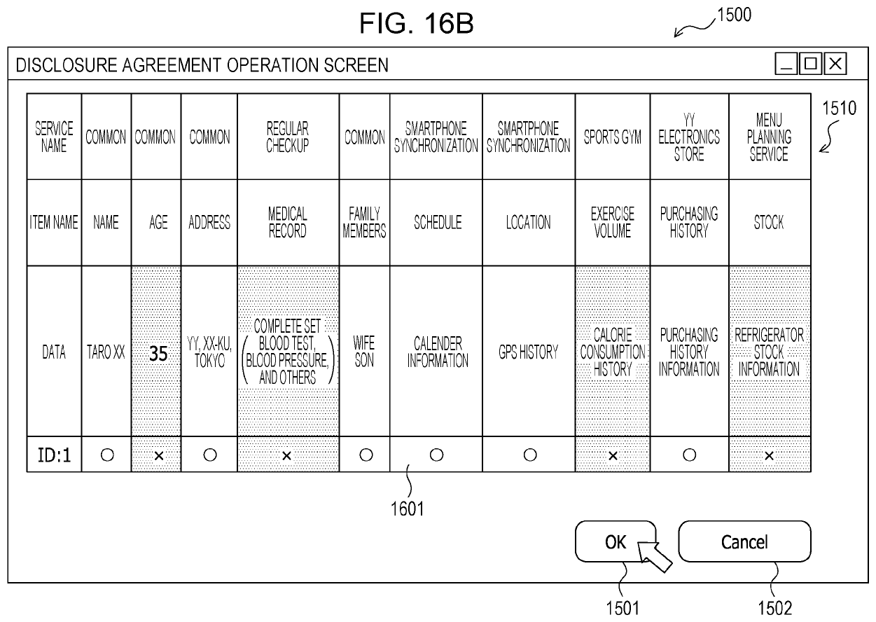

In the disclosure agreement operation screen 1500, when the alternative choice 1602 is clicked as illustrated in FIG. 16A, the choice displayed in the cell 1601 is changed from “× (disclosure refusal)” to “∘ (disclosure agreement)” as illustrated in FIG. 16B.

In the disclosure agreement operation screen 1500, when an OK button 1501 is clicked, the disclosure agreements and refusals of the respective items are each determined as the set choice “o and x” displayed in the associated cell. In the disclosure agreement operation screen 1500, when a cancel bottom 1502 is clicked, the settings for information disclosure to the service Si for the target user are canceled.

In another example, when the cell 1601 is double-clicked in the disclosure agreement operation screen 1500 illustrated in FIG. 15B, additional information 1700 as illustrated in FIG. 17 is displayed in a pop-up window. The additional information 1700 is information indicating items highly related to the item with the item name “SCHEDULE” regarding whether the disclosure is agreed.

For instance, the additional information 1700 indicates the disclosure agreement or refusal, the service name, the item name, and the item data of each of other items related to the item with the item name “SCHEDULE” in the case where the disclosure agreement choice of the item is set to “× (disclosure refusal)”. In the additional information 1700, the items with the disclosure agreements are displayed collectively on the upper side, which makes it easy to recognize the disclosure agreement or refusal of each of the items.

By viewing the additional information 1700, the target user is able to know the disclosure agreements and refusals of the other items set by a majority of users as presented in the additional information 1700 in the case where the disclosure agreement choice of the item with the item name “SCHEDULE” is set to “× (disclosure refusal)”.

In the disclosure agreement operation screen 1500 illustrated in FIG. 17, when an OK bottom 1701 is clicked, the disclosure agreements and refusals are collectively set for the item with the item name “SCHEDULE” and the other items highly related to the item with the item name “SCHEDULE” regarding whether the disclosure is agreed. For instance, the choice displayed in the cell 1601 is set for the item with the item name “SCHEDULE”, the choices displayed in the additional information 1700 are set for the other items, and the display of the additional information 1700 is terminated.

In the disclosure agreement operation screen 1500 illustrated in FIG. 17, when a cancel bottom 1702 is clicked, the display of the additional information 1700 is terminated.

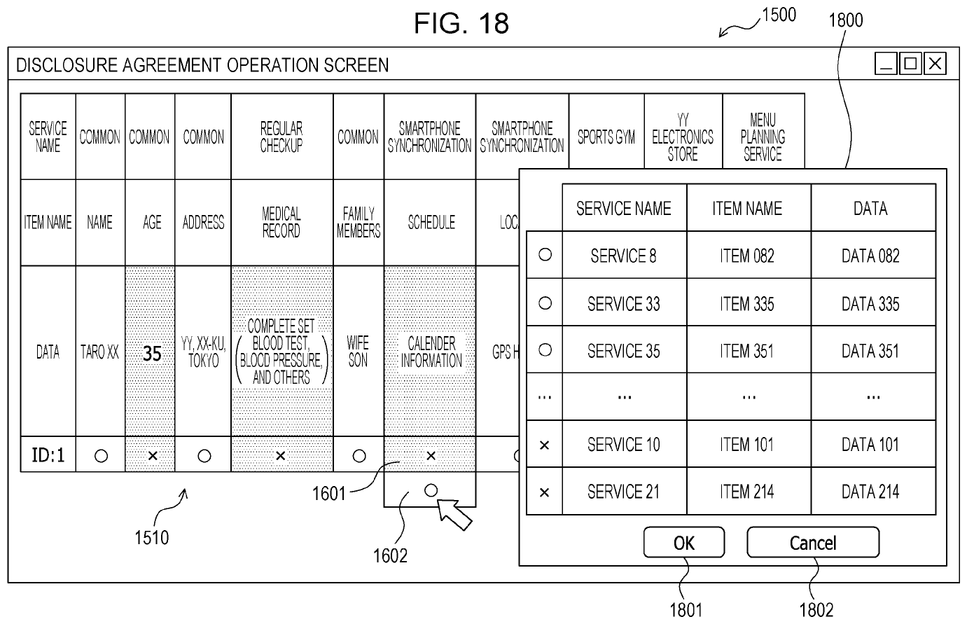

For example, when the alternative choice 1602 is double-clicked in the disclosure agreement operation screen 1500 illustrated in FIG. 15B, additional information 1800 as illustrated in FIG. 18 is displayed in a pop-up window. The additional information 1800 is information indicating items highly related to the item with the item name “SCHEDULE” regarding whether the disclosure is agreed.

For instance, the additional information 1800 indicates the disclosure agreement or refusal, the service name, the item name, and the item data of each of other items related to the item with the item name “SCHEDULE” in the case where the disclosure agreement choice of the item is set to “∘ (disclosure agreement)”. In the additional information 1800, the items with the disclosure agreements are displayed collectively on the upper side, which makes it easy to recognize the disclosure agreement or refusal for each of the items.

By viewing the additional information 1800, the target user is able to know the disclosure agreements and refusals of the other items set by a majority of users as presented in the additional information 1800 in the case where the disclosure agreement choice of the item with the item name “SCHEDULE” is set to “∘ (disclosure agreement)”.

In the disclosure agreement operation screen 1500 illustrated in FIG. 18, when an OK bottom 1801 is clicked, the disclosure agreements and refusals are collectively set for the item with the item name “SCHEDULE” and the other items highly related to the item with the item name “SCHEDULE” regarding whether the disclosure is agreed. For instance, the choice displayed in the alternative choice 1602 is set for the item with the item name “SCHEDULE”, the choices displayed in the additional information 1800 are set for the other items, and the display of the additional information 1800 is terminated.

In the disclosure agreement operation screen 1500 illustrated in FIG. 18, when a cancel bottom 1802 is clicked, the display of the additional information 1800 is terminated.

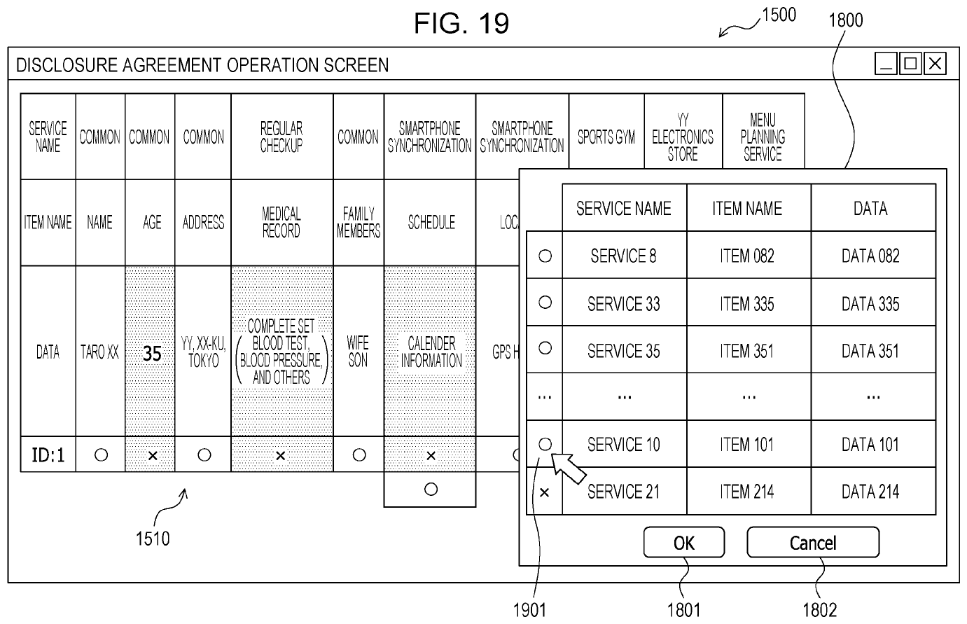

For example, in the disclosure agreement operation screen 1500 illustrated in FIG. 18, a click operation on any of cells being displayed in the additional information 1800 and presenting the disclosure agreements and refusals set for the respective other items allows the disclosure agreement or refusal in the clicked cell to be changed. In an example of FIG. 19, as a result of clicking a cell 1901, the disclosure agreement choice of the item with the service name “SERVICE 10”, the item name “ITEM 101”, and the item data “DATA 101” is changed from “× (disclosure refusal)” to “∘ (disclosure agreement)”.

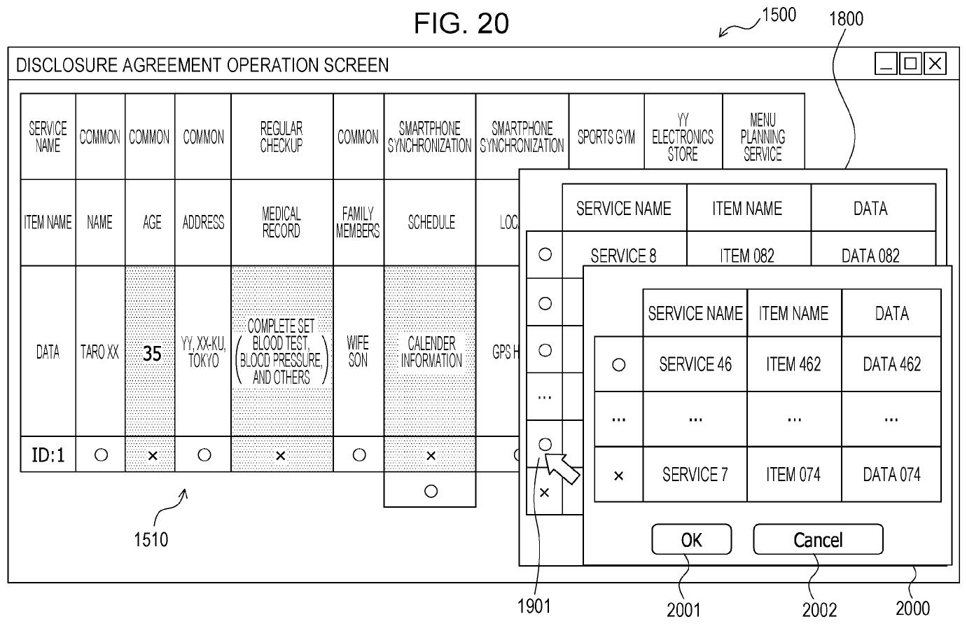

In another example, when the cell 1901 is double-clicked in the disclosure agreement operation screen 1500 illustrated in FIG. 19, additional information 2000 as illustrated in FIG. 20 is further displayed in a pop-up window. The additional information 2000 is information indicating items highly related to the item with the service name “SERVICE 10”, the item name “ITEM 101”, and the item data “DATA 101” regarding whether the disclosure is agreed.

For instance, the additional information 2000 indicates the disclosure agreement or refusal, the service name, the item name, and the item data of each of other items related to the item with the item name “ITEM 101” in the case where the disclosure agreement choice of the item is set to “∘ (disclosure agreement)”. Items that are also displayed on the additional information 1800 may be omitted from the additional information 2000.

By viewing the additional information 2000, the target user is able to know the disclosure agreements and refusals of the other items set by a majority of users as presented in the additional information 2000 in the case where the disclosure agreement choice of the item with the item name “ITEM 101” is set to “∘ (disclosure agreement)”.

In the disclosure agreement operation screen 1500 illustrated in FIG. 20, when an OK bottom 2001 is clicked, the disclosure agreements and refusals are collectively set for the item with the item name “ITEM 101” and the other items highly related to the item with the item name “ITEM 101” regarding whether the disclosure is agreed. For instance, the choice displayed in the cell 1901 is set for the item with the item name “ITEM 101”, the choices displayed in the additional information 2000 are set for the other items, and the display of the additional information 2000 is terminated.

In the disclosure agreement operation screen 1500 illustrated in FIG. 20, when a cancel bottom 2002 is clicked, the display of the additional information 2000 is terminated.

Processing Procedure for Disclosure Information Setting in Information Processing Apparatus 101

Next, description is provided for a processing procedure for disclosure information setting in the information processing apparatus 101.

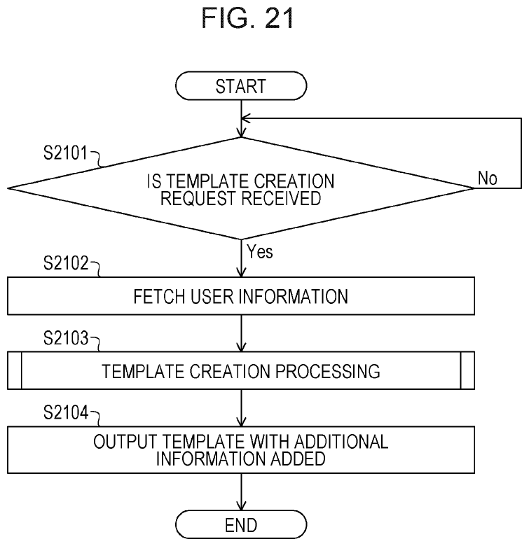

FIG. 21 is a flowchart illustrating an example of the processing procedure for the disclosure information setting in the information processing apparatus 101. In the flowchart of FIG. 21, the information processing apparatus 101 first judges whether a template creation request is received from the terminal device 201 (step S2101). Here, the information processing apparatus 101 waits for reception of a template creation request (step S2101: No).

Then, when the information processing apparatus 101 receives a template creation request (step S2101: Yes), the information processing apparatus 101 fetches the user information on a target user by referring to the user information DB 230 (step S2102). The target user is identified from the target user ID contained in the template creation request.

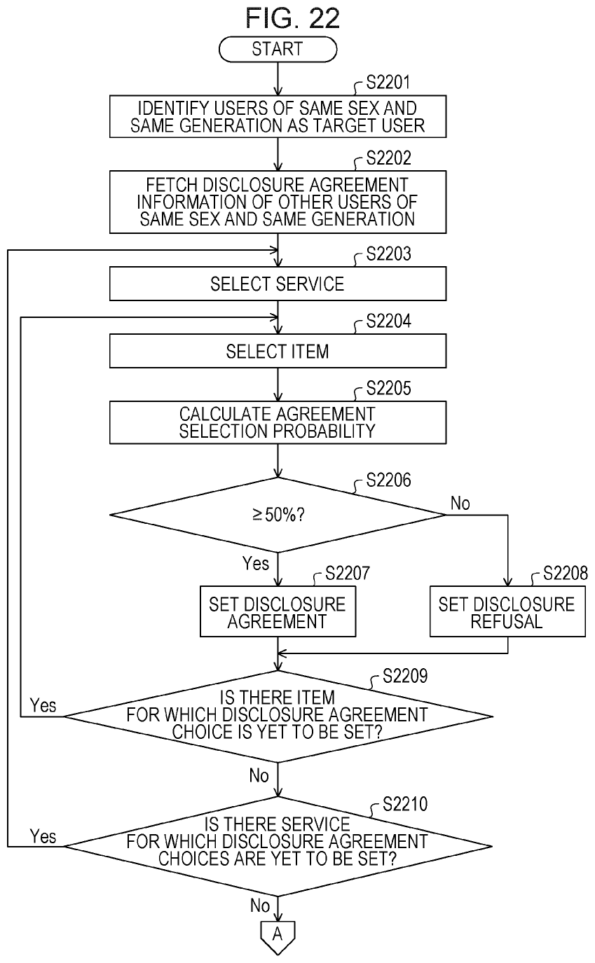

Next, the information processing apparatus 101 executes template creation processing according to a template type and an additional information type contained in the template creation request (step S2103). Specific processing procedures for the template creation processing will be described later with reference to FIGS. 22, 23, and 25 to 30.

Then, the information processing apparatus 101 outputs the created template with the additional information added to the terminal device 201 (step S2104), and terminates the series of processes according to the present flowchart.

Thus, it is possible to present, to a user of the terminal device 201 (for example, a target user), the template in which a disclosure agreement or refusal of each of the items for the service Si is set in advance and also the additional information that assists the user to select a disclosure agreement or refusal for each of the items.

Specific Processing Procedure for Template Creation Processing

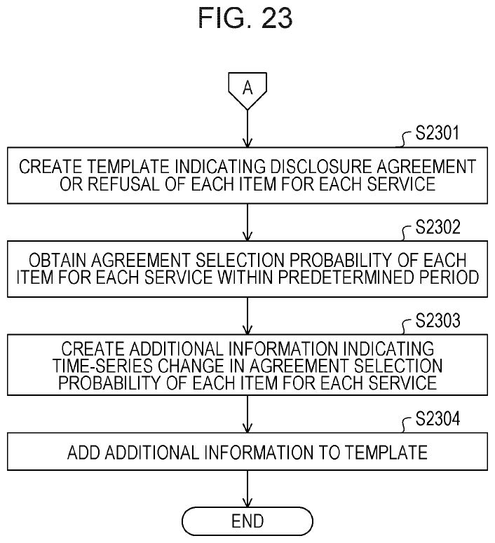

Next, the specific processing procedures for the template creation processing in step S2103 illustrated in FIG. 21 are described. First, with reference to FIGS. 22 and 23, description is provided for a specific processing procedure for the template creation processing according to the template type “same sex×same generation” and the additional information type “time-series information”.

FIGS. 22 and 23 present a flowchart of an example of the specific processing procedure for the template creation processing according to the template type “same sex×same generation” and the additional information type “time-series information”. In the flowchart of FIG. 22, the information processing apparatus 101 first identifies the sex and generation of the target user by referring to the user information fetched in step S2102 (step S2201).

Then, the information processing apparatus 101 fetches the disclosure agreement information associated with the item IDs of other users of the sex and generation identical to the identified sex and generation of the target user from the disclosure agreement information DB 250 (step S2202). Next, the information processing apparatus 101 selects a service Si for which disclosure agreement choices are yet to be set among the services S1 to Sn (step S2203).

Thereafter, the information processing apparatus 101 selects an item for which a disclosure agreement choice is yet to be set from among the items for the selected service Si (step S2204). Subsequently, the information processing apparatus 101 calculates the agreement selection probability of the selected item based on the fetched disclosure agreement information (step S2205).

Then, the information processing apparatus 101 judges whether the calculated agreement selection probability is equal to or more than 50% (step S2206). Here, when the agreement selection probability is equal to or more than 50% (step S2206: Yes), the information processing apparatus 101 sets a disclosure agreement for the selected item (step S2207), and proceeds to step S2209.

On the other hand, when the agreement selection probability is less than 50% (step S2206: No), the information processing apparatus 101 sets a disclosure refusal for the selected item (step S2208). Then, the information processing apparatus 101 judges whether there is an item for which a disclosure agreement choice is yet to be set among the items for the selected service Si (step S2209).

Here, when there is an item for which a disclosure agreement choice is yet to be set (step S2209: Yes), the information processing apparatus 101 returns to step S2204. On the other hand, when there is no item for which a disclosure agreement choice is yet to be set (step S2209: No), the information processing apparatus 101 judges whether there is a service Si for which disclosure agreement choices are yet to be set among the services S1 to Sn (step S2210).

When there is a service Si for which disclosure agreement choices are yet to be set (step S2210: Yes), the information processing apparatus 101 returns to step S2203. On the other hand, when there is no service Si for which disclosure agreement choices are yet to be set (step S2210: No), the information processing apparatus 101 proceeds to step S2301 illustrated in FIG. 23.

In the flowchart of FIG. 23, the information processing apparatus 101 first creates a template for each service Si indicating a disclosure agreement or refusal of each of the items set in step S2207 or S2208 (step S2301).

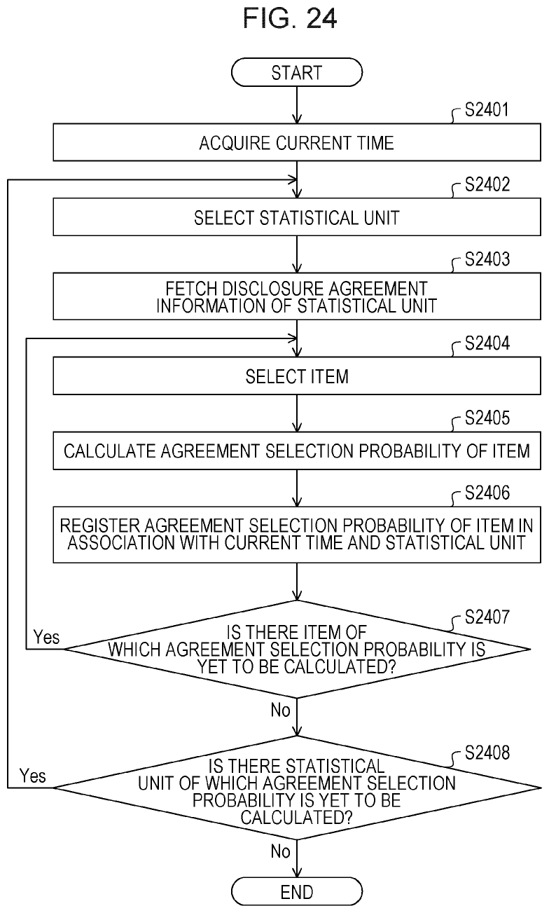

Then, for each service Si, the information processing apparatus 101 fetches the agreement selection probability of each item within a given period T for the statistical unit of the same sex and same generation as the target user from the time-series information DB 1200 (step S2302). An update processing procedure of the time-series information DB 1200 will be described later with reference to FIG. 24.

Next, for each service Si, the information processing apparatus 101 creates additional information indicating a time-series change in the agreement selection probability of each item within the given period T based on the fetched agreement selection probability of the item within the given period T (step S2303). Then, the information processing apparatus 101 adds the created additional information to the created template (step S2304), and returns to the step where the template creation processing is invoked.

Thus, for each of the services S1 to Sn, it is possible to create a template in which the information disclosure setting tendency of the users of the same sex and same generation as the target user is reflected. For each of the services S1 to Sn, it is possible to create additional information indicating a time-series change in the agreement selection probability of each item within the given period T for the users of the same sex and same generation as the target user.

Update Processing Procedure of Time-Series Information DB 1200

Next, with reference to FIG. 24, description is provided for the update processing procedure of the time-series information DB 1200. The update processing of the time-series information DB 1200 is executed, for example, every day at midnight.

FIG. 24 is a flowchart illustrating an example of the update processing procedure of the time-series information DB 1200. In the flowchart of FIG. 24, the information processing apparatus 101 first acquires a current time (step S2401). Then, the information processing apparatus 101 selects a statistical unit for which the agreement selection probability is yet to be calculated from among preset statistical (step S2402).

Next, the information processing apparatus 101 fetches the disclosure agreement information of the selected statistical unit from the disclosure agreement information DB 250 (step S2403). The disclosure agreement information of which users in the disclosure agreement information DB 250 belongs to which statistical unit is identified from the user information in the user information DB 230, for example.

Subsequently, the information processing apparatus 101 selects an item of which the agreement selection probability is yet to be calculated from among the items for all the services S1 to Sn (step S2404). Then, the information processing apparatus 101 calculates the agreement selection probability of the selected item based on the fetched disclosure agreement information of the statistical unit (step S2405).

Thereafter, the information processing apparatus 101 registers the calculated agreement selection probability of the item in association with the acquired current time and the selected statistical unit into the time-series information DB 1200 (step S2406). After that, the information processing apparatus 101 judges whether there is an item of which the agreement selection probability is yet to be calculated among the items for all the selected service S1 to Sn (step S2407).

When there is an item of which the agreement selection probability is yet to be calculated (step S2407: Yes), the information processing apparatus 101 returns to step S2404. On the other hand, when there is no item of which the agreement selection probability is yet to be calculated (step S2407: No), the information processing apparatus 101 judges whether or not there is a statistical unit for which the agreement selection probability is yet to be calculated among the preset statistical units (step S2408).

When there is a statistical unit for which the agreement selection probability is yet to be calculated (step S2408: Yes), the information processing apparatus 101 returns to step S2402. On the other hand, when there is no statistical unit for which the agreement selection probability is yet to be calculated (step S2408: No), the information processing apparatus 101 terminates the series of processes according to the present flowchart.

In this way, for each of the services S1 to Sn, it is possible to record the agreement selection probability of each of the items for each of the preset statistical units into the time-series information DB 1200.

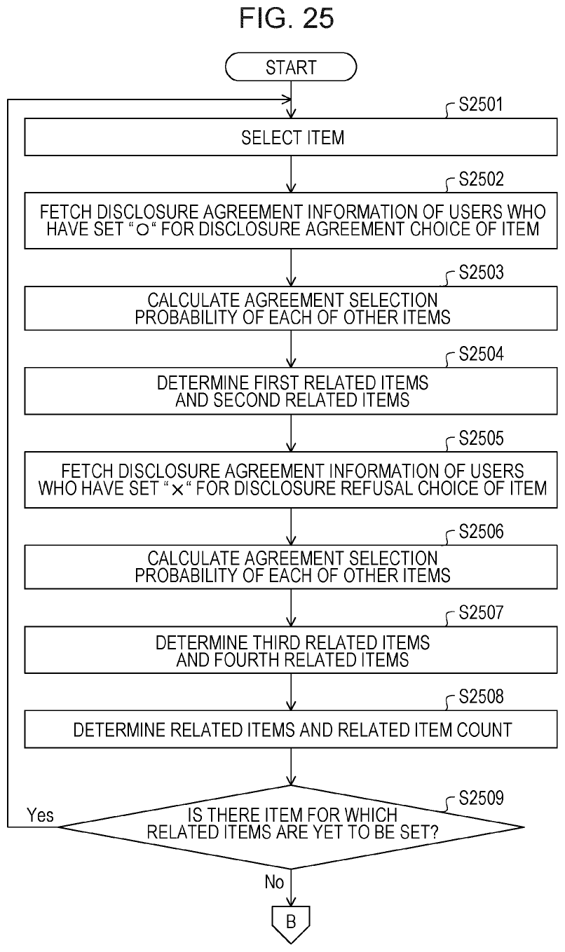

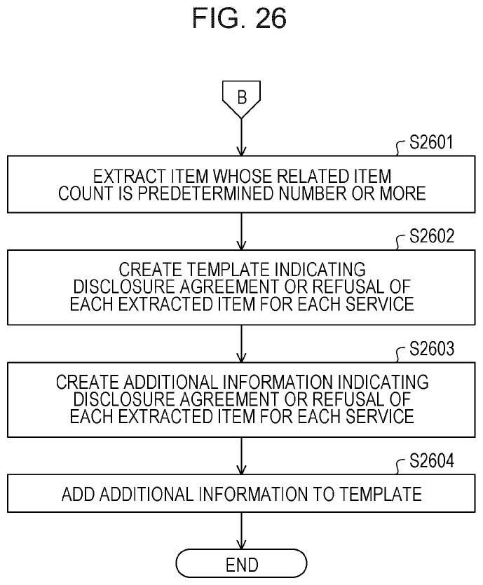

Next, with reference to FIGS. 25 and 26, description is provided for a specific processing procedure of template creation processing according to the template type “item-related information” and the additional information type “item-related information”.

FIGS. 25 and 26 present a flowchart illustrating an example of the specific processing procedure of the template creation processing according to the template type “item-related information” and the additional information type “item-related information”. In the flowchart of FIG. 25, the information processing apparatus 101 first selects an item for which related items are yet to be set from among the items for all the services S1 to Sn (step S2501).

Next, the information processing apparatus 101 fetches the disclosure agreement information of the other items (also referred to as the concerned items) for users who have set the disclosure agreement choice of the selected item to “∘ (disclosure agreement)” from the disclosure agreement information DB 250 (step S2502). Then, the information processing apparatus 101 calculates the agreement selection probability of each of the concerned items based on the fetched disclosure agreement information of the concerned item (step S2503).

After that, the information processing apparatus 101 determines each concerned item having a calculated agreement selection probability equal to or more than the threshold β as a related item (first related item), and determines each concerned item having a calculated agreement selection probability less than the threshold γ as a related item (second related item) (step S2504)

Next, the information processing apparatus 101 fetches the disclosure agreement information of the other concerned items for users who have set the disclosure agreement choice of the selected item to “× (disclosure refusal)” from the disclosure agreement information DB 250 (step S2505). Then, the information processing apparatus 101 calculates the agreement selection probability of each of the concerned items based on the fetched disclosure agreement information of the concerned item (step S2506).

After that, the information processing apparatus 101 determines each concerned item having a calculated agreement selection probability equal to or more than the threshold β as a related item (third related item), and determines each concerned item having a calculated agreement selection probability less than the threshold γ as a related item (fourth related item) (step S2507).

Then, the information processing apparatus 101 determines, as related items, the determined first, second, third, and fourth related items, and determines, as the related item count, the total number of the determined related items (step S2508). For instance, the first and second related items are related items in the case where the disclosure agreement choice of the selected item is “∘ (disclosure agreement)”. The third and fourth related items are related items in the case where the disclosure agreement choice of the selected item is “× (disclosure refusal)”.

After that, the information processing apparatus 101 judges whether there is an item for which related items are yet to be set among the items for all the selected service S1 to Sn (step S2509). When there is an item for which related items are yet to be set (step S2509: Yes), the information processing apparatus 101 returns to step S2501.

On the other hand, when there is no item for which related items are yet to be set (step S2509: No), the information processing apparatus 101 proceeds to step S2601 in FIG. 26.

In the flowchart of FIG. 26, the information processing apparatus 101 extracts an item whose related item count determined is equal to or more than a predetermined number q among the items for all the services S1 to Sn (step S2601). Then, for each service Si, the information processing apparatus 101 creates a template indicating a disclosure agreement or refusal of each of the extracted items (step S2602).

Next, for each service Si, the information processing apparatus 101 creates the additional information indicating a disclosure agreement or refusal of each of the determined related items, that is, the items highly related to each of the extracted items regarding whether to agree with the disclosure (step S2603). This additional information is, for example, information that enables the disclosure agreements and refusals to be set collectively for the extracted item and the determined related items. Then, the information processing apparatus 101 adds the created additional information to the created template (step S2604), and returns to the step where the template creation processing is invoked.

In this way, it is possible to create a template in which only items highly related to other items regarding whether the disclosure is agreed are picked out among the items for each service Si. It is also possible to create additional information indicating the disclosure agreements and refusals of the other items highly related to the items for the service Si regarding whether the disclosure is agreed.

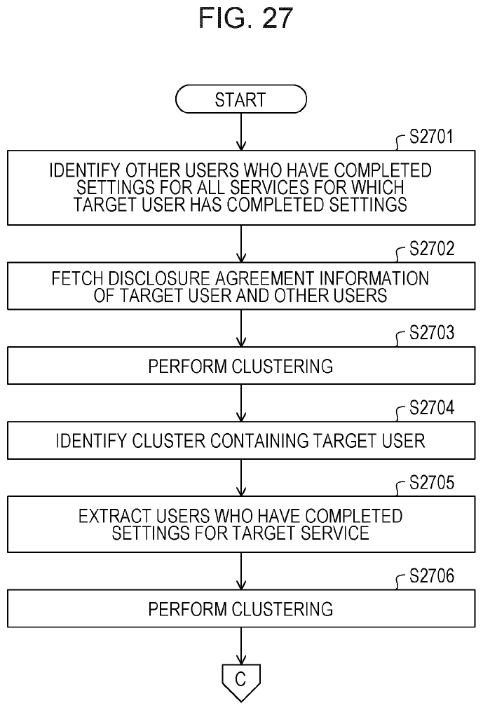

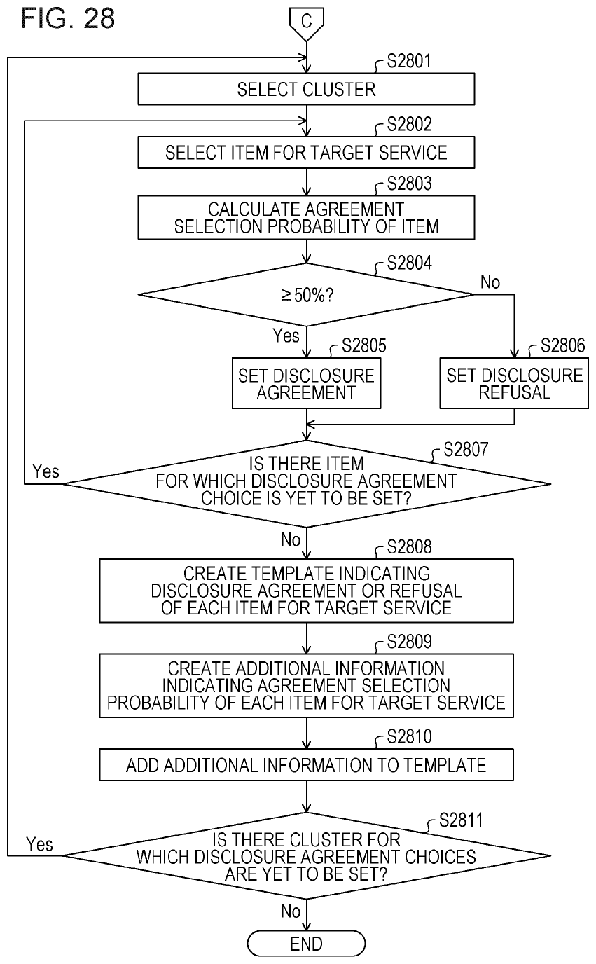

Next, with reference to FIGS. 27 and 28, description is provided for a specific processing procedure of first template creation processing according to the template type “clustering” and the additional information type “clustering agreement selection probability”.

FIGS. 27 and 28 present a flowchart illustrating an example of the specific processing procedure of the first template creation processing according to the template type “clustering” and the additional information type “clustering agreement selection probability”. In the flowchart of FIG. 27, by referring to the user information DB 230, the information processing apparatus 101 first identifies other users who have completed the settings for information disclosure to all the services to which the target user has completed the settings for information disclosure among the services S1 to Sn (step S2701).

Next, the information processing apparatus 101 fetches the disclosure agreement information of each of the items for the services S1 to Sn for the target user and the identified users from the disclosure agreement information DB 250 (step S2702). Then, the information processing apparatus 101 performs clustering based on the fetched disclosure agreement information (step S2703).

Next, the information processing apparatus 101 identifies a cluster containing the target user among the clusters formed by clustering (step S2704). Thereafter, by referring to the user information DB 230, the information processing apparatus 101 extracts users who have completed the settings for information disclosure to the target service from among the other users different from the target user in the identified cluster (step S2705).

Subsequently, the information processing apparatus 101 performs clustering based on the disclosure agreement information of the items for the target service for the extracted users by referring to the disclosure agreement information DB 250 (step S2706), and proceeds to step S2801 presented in FIG. 28.

In the flowchart of FIG. 28, the information processing apparatus 101 first selects a cluster for which disclosure agreement choices are yet to be set among the clusters formed by clustering in step S2706 (step S2801). Next, the information processing apparatus 101 selects an item for which a disclosure agreement choice is yet to be set among the items for the target service (step S2802).

Then, the information processing apparatus 101 calculates the agreement selection probability of the selected item based on the disclosure agreement information of the selected item for the users in the selected cluster by referring to the disclosure agreement information DB 250 (step S2803).

Thereafter, the information processing apparatus 101 judges whether the calculated agreement selection probability is equal to or more than 50% (step S2804). Here, when the agreement selection probability is equal to or more than 50% (step S2804: Yes), the information processing apparatus 101 sets a disclosure agreement for the selected item (step S2805), and proceeds to step S2807.

On the other hand, when the agreement selection probability is less than 50% (step S2804: No), the information processing apparatus 101 sets a disclosure refusal for the selected item (step S2806). Then, the information processing apparatus 101 judges whether there is an item for which a disclosure agreement choice is yet to be set among the items for the target service (step S2807).

Here, when there is an item for which a disclosure agreement choice is yet to be set (step S2807: Yes), the information processing apparatus 101 returns to step S2802. On the other hand, when there is no item for which a disclosure agreement choice is yet to be set (step S2807: No), the information processing apparatus 101 creates the template for the target service indicating a disclosure agreement or refusal of each item set in step S2805 or S2806 (step S2808).

Next, the information processing apparatus 101 creates the additional information indicating the agreement selection probability of each item for the target service based on the calculated agreement selection probability of the item (step S2809). Then, the information processing apparatus 101 adds the created additional information to the created template (step S2810).

Subsequently, the information processing apparatus 101 judges whether there is a cluster for which disclosure agreement choices are yet to be set among the clusters formed by clustering in step S2706 (step S2811). Here, when there is a cluster for which disclosure agreement choices are yet to be set (step S2811: Yes), the information processing apparatus 101 returns to step S2801.

On the other hand, when there is no cluster for which disclosure agreement choices are yet to be set (step S2811: No), the information processing apparatus 101 returns to the step where the first template creation processing is invoked.

In this way, it is possible to create, for each of the clusters formed by clustering user group who have the information disclosure setting tendency similar to that of the target user, the template in which a disclosure agreement or refusal of each of the items for the target service is set in advance and the additional information indicating the agreement selection probability of each of the items for the target service.

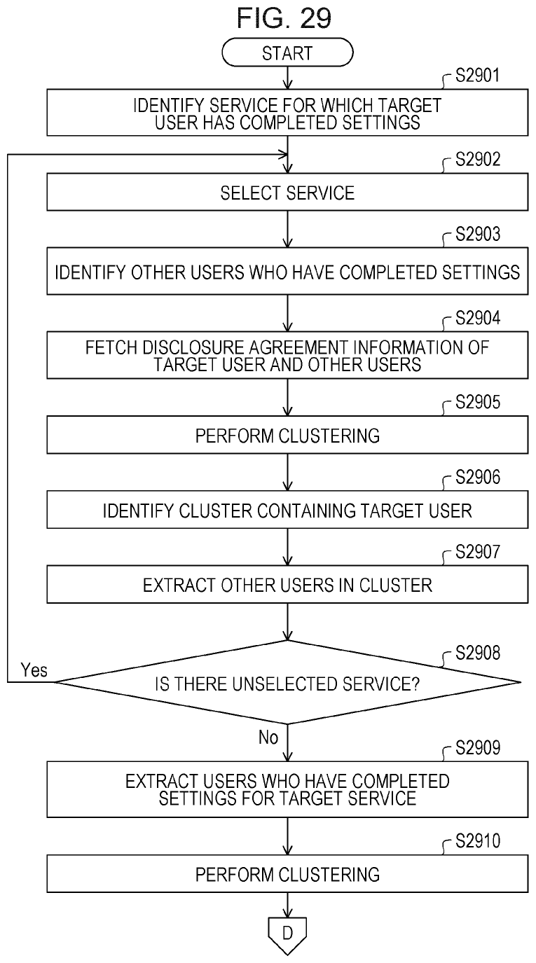

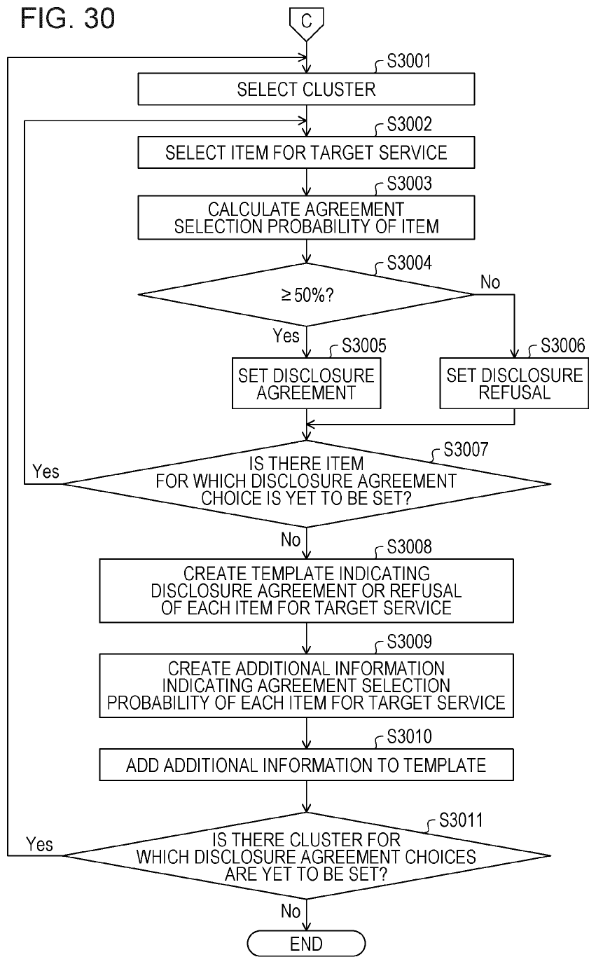

Next, with reference to FIGS. 29 and 30, description is provided for a specific processing procedure of second template creation processing according to the template type “clustering” and the additional information type “clustering agreement selection probability”. The second template creation processing is different from the first template creation processing in a process of identifying a user group which has the information disclosure setting tendency similar to that of the target user.

FIGS. 29 and 30 present a flowchart illustrating an example of the specific processing procedure of the second template creation processing according to the template type “clustering” and the additional information type “clustering agreement selection probability”. In the flowchart of FIG. 29, by referring to the user information DB 230, the information processing apparatus 101 first identifies services to which the target user has completed the settings for information disclosure among the services S1 to Sn (step S2901).

Next, the information processing apparatus 101 selects an unselected service Si, a service yet to be selected, among the identified services (step S2902). Then, by referring to the user information DB 230, the information processing apparatus 101 identifies other users who have completed the settings for information disclosure to the selected service Si (step S2903).

Subsequently, the information processing apparatus 101 fetches the disclosure agreement information of each of the items for the service Si for the target user and the identified other users from the disclosure agreement information DB 250 (step S2904). Then, the information processing apparatus 101 performs clustering based on the fetched disclosure agreement information (step S2905).

Next, the information processing apparatus 101 identifies a cluster containing the target user among the clusters formed by clustering (step S2906). Thereafter, by referring to the user information DB 230, the information processing apparatus 101 extracts other users different from the target user in the identified cluster (step S2907).

Next, the information processing apparatus 101 selects an unselected service Si, a service yet to be selected, among the services identified in step S2901 (step S2908). Here, when there is an unselected service Si (step S2908: Yes), the information processing apparatus 101 returns to step S2902.

On the other hand, when there is no unselected service Si (step S2908: No), the information processing apparatus 101 extracts users who have completed the settings for information disclosure to the target service from the other users extracted in step S2907 (step S2909). Subsequently, the information processing apparatus 101 performs clustering based on the disclosure agreement information of the items for the target service for the extracted users by referring to the disclosure agreement information DB 250 (step S2910), and proceeds to step S3001 presented in FIG. 30.

In the flowchart of FIG. 30, the information processing apparatus 101 selects a cluster for which disclosure agreement choices are yet to be set among the clusters formed by clustering in step S2910 (step S3001). Next, the information processing apparatus 101 selects an item for which a disclosure agreement choice is yet to be set among the items for the target service (step S3002).

Then, the information processing apparatus 101 calculates the agreement selection probability of the selected item based on the disclosure agreement information of the selected item for the users in the selected cluster by referring to the disclosure agreement information DB 250 (step S3003).

Thereafter, the information processing apparatus 101 judges whether the calculated agreement selection probability is equal to or more than 50% (step S3004). Here, when the agreement selection probability is equal to or more than 50% (step S3004: Yes), the information processing apparatus 101 sets a disclosure agreement for the selected item (step S3005), and proceeds to step S3007.

On the other hand, when the agreement selection probability is less than 50% (step S3004: No), the information processing apparatus 101 sets a disclosure refusal for the selected item (step S3006). Then, the information processing apparatus 101 judges whether there is an unselected item, an item yet to be selected, among the items for the target service (step S3007).

Here, when there is an item for which a disclosure agreement choice is yet to be set (step S3007: Yes), the information processing apparatus 101 returns to step S3002. On the other hand, when there is no item for which a disclosure agreement choice is yet to be set (step S3007: No), the information processing apparatus 101 creates the template for the target service indicating a disclosure agreement or refusal of each item set in step S3005 or S3006 (step S3008).

Next, the information processing apparatus 101 creates the additional information indicating the agreement selection probability of each item for the target service based on the calculated agreement selection probability of the item (step S3009). Then, the information processing apparatus 101 adds the created additional information to the created template (step S3010).

Subsequently, the information processing apparatus 101 judges whether there is a cluster for which disclosure agreement choices are yet to be set among the clusters formed by clustering in step S2910 (step S3011). Here, when there is a cluster for which disclosure agreement choices are yet to be set (step S3011: Yes), the information processing apparatus 101 returns to step S3001.

On the other hand, when there is no cluster for which disclosure agreement choices are yet to be set (step S3011: No), the information processing apparatus 101 returns to the step where the second template creation processing is invoked.

In this way, it is possible to create, for each of the clusters formed by clustering user group who have the information disclosure setting tendency similar to that of the target user, the template in which a disclosure agreement or refusal of each of the items for the target service is set in advance and the additional information indicating the agreement selection probability of each of the items for the target service.

Presentation Processing Procedure in Terminal Device 201

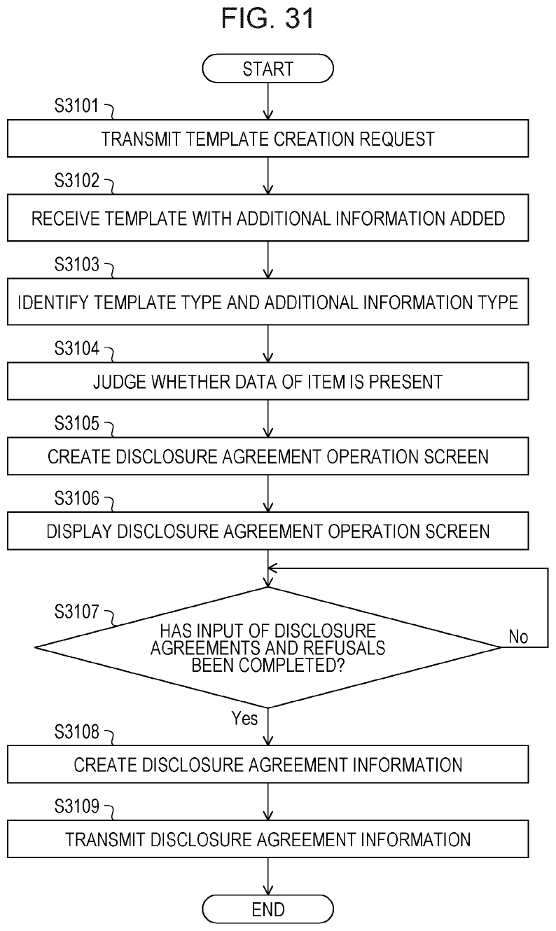

Next, with reference to FIG. 31, description is provided for the presentation processing procedure in the terminal device 201.

FIG. 31 is a flowchart illustrating an example of the presentation processing procedure in the terminal device 201. In the flowchart of FIG. 31, the terminal device 201 first transmits a template creation request to the information processing apparatus 101 (step S3101). The template creation request includes, for example, a target user ID, a template type, and an additional information type.

Then, the terminal device 201 receives, as a response to the transmitted template creation request, the template with the additional information added from the information processing apparatus 101 (step S3102). Next, the terminal device 201 identifies the designated template type and additional information type (step S3103).

Next, the terminal device 201 judges whether there are data of the items (item values) for each service Si (step S3104). The terminal device 201 may inquire of the information processing apparatus 101 the data of the items for the service Si. Then, the terminal device 201 creates screen information of the disclosure agreement operation screen according to the received template with the additional information added, the identified template type and additional information type, and a result of determining whether there are data of the items (item values) (step S3105).

Next, the terminal device 201 displays the disclosure agreement operation screen on the display 406 based on the generated screen information of the disclosure agreement operation screen (step S3106). Then, the terminal device 201 judges whether the target user has completed input of a disclosure agreement or refusal of each of the items for the service Si (step S3107).

Here, the terminal device 201 waits for the input of the disclosure agreements and refusals (step S3107: No). When the input of the disclosure agreements and refusals has been completed (step S3107: Yes), the terminal device 201 creates the disclosure agreement information based on the input result of the disclosure agreements and refusals of each of the items for the service Si (step S3108).

Then, the terminal device 201 transmits the created disclosure agreement information to the information processing apparatus 101 (step S3109), and terminates the series of processes according to the present flowchart. As a result, the information processing apparatus 101 registers the disclosure agreement information transmitted from the terminal device 201 into the disclosure agreement information DB 250.

In this way, it is possible for the target user to make the settings for information disclosure to the service Si by using the template with the additional information added provided from the information processing apparatus 101. The screen information of the disclosure agreement operation screen may be generated in the information processing apparatus 101.

As described above, in order for the target user to make the settings for information disclosure to the service Si, the information processing apparatus 101 in the embodiment is able to create the template and the additional information based on the setting information indicating the disclosure agreements and refusals of each item set by the other users who have completed the settings for information disclosure to the service Si. Here, the template is information in which a disclosure agreement or refusal of each item for the service Si is set in advance. The additional information is information that gives assistance for selecting a disclosure agreement or refusal of each item for the service Si. Then, the information processing apparatus 101 is able to output the created template and additional information.

This makes it easy for a target user (information provider) who desires to use a service Si provided by an information user to set disclosure agreements and refusals of personal information. For example, presenting a template in which a disclosure agreement or refusal of each of the items for the service Si is set in a changeable manner reduces the work for the setting operation as compared with the case where a disclosure agreement or refusal of each of the items is set from scratch. The information that assists the user to select a disclosure agreement or refusal of each of the items for the service Si is presented together with the template. This facilitates the settings of disclosure agreements and refusals of the respective items for the service Si. For example, in the template, presented is the statistical information which indicates the grounds for setting the disclosure agreement or refusal in advance for each of the items. This facilitate judgment on whether it is all right to follow the template. The information that enables the user to make the settings for multiple items by carrying out a single setting operation is presented, which results in a reduction in the work for the setting operation.

The information processing apparatus 101 is able to create the additional information indicating a percentage of users who have set a disclosure agreement for each of the items for the service Si among the other users who have completed the settings for information disclosure to the service Si (agreement selection probability).

This allows a user to know what percentage of other users agree to disclose each of the items for the service Si, and thus easily judge whether it is all right to follow the template.

The information processing apparatus 101 is able to create the additional information that enables disclosure agreements to be set collectively for items each having an agreement selection probability equal to or more than the threshold β among the items for the service Si.

This makes it possible to set “disclosure agreements” collectively for items for which a majority of users agree among the items for the service Si by carrying out a single setting operation, which results in a reduction in the number of items to be checked in the setting operation and accordingly a reduction in the work for the setting operation.

The information processing apparatus 101 is able to create the additional information that enables disclosure refusals to be set collectively for items each having an agreement selection probability less than the threshold γ among the items for the service Si.

This makes it possible to set “disclosure refusals” collectively for items for which a majority of users refuse among the items for the service Si by carrying out a single setting operation, which results in a reduction in the number of items to be checked in the setting operation and accordingly a reduction in the work for the setting operation.

The information processing apparatus 101 is able to create the additional information indicating a time-series change in the agreement selection probability of each of the items for a service Si within a given period T.

This allows a user to know a change trend in the percentage of the other users who agree with the information disclosure of each of the items for the service Si within the given period T (for example, within the most recent one month), and thus easily judge whether it is all right to follow the template.

The information processing apparatus 101 is able to identify users of the sex and generation, at least one of which is the same as the target user, from among the other users who have completed the settings for information disclosure to the service Si.

Thus, it is possible to create the template and the additional information for the service Si in which the information disclosure setting tendency of the users of the same sex and/or generation as the target user is reflected. This makes it possible to provide an effective judgment basis for judging whether to agree with disclosure even for a service Si for which the setting tendency varies depending on the sex and generation of the user (person who discloses information).

The information processing apparatus 101 is able to identify other users who have completed the settings for information disclosure to all the services to which the target user has completed the settings for information disclosure among the services S1 to Sn, and identify the user group which has the information disclosure setting tendency similar to that of the target user based on the setting information indicating the disclosure agreements and refusals of each of the items for the services S1 to Sn set by the target user and the identified other users. Then, the information processing apparatus 101 is able to create the template for the target service based on the setting information indicating the disclosure agreements and refusals of each of the items for the target service set by the respective users in the identified user group.

Thus, it is possible to create the template for the designated target service in which reflected is the setting tendency in the disclosure agreement or refusal of each of the items of the users who have the information disclosure setting tendency similar to that of the target user.

For each service to which the target user has completed the settings for information disclosure among the services S1 to Sn, the information processing apparatus 101 is able to identify a user group which has the information disclosure setting tendency similar to that of the target user based on the setting information indicating the disclosure agreements and refusals of each of the items set by the users who have completed the settings for information disclosure to the concerned service. Then, the information processing apparatus 101 is able to create the template for the target service based on the setting information indicating the disclosure agreements and refusals of each of the items for the target service set by the respective users in the identified user group.

Thus, it is possible to create the template for the designated target service in which reflected is the setting tendency in the disclosure agreement or refusal of each of the items of the users who have the information disclosure setting tendency similar to that of the target user.

The information processing apparatus 101 is able to determine a relation between the items for the services S1 to Sn regarding whether the disclosure is agreed based on the setting information indicating the disclosure agreements and refusals of each item set by the other users who have already completed the settings for information disclosure to the services S1 to Sn. Then, the information processing apparatus 101 is able to create, based on the relations determined as a result, the additional information that enables disclosure agreements and refusals to be set collectively for a particular item for the service Si and other items highly related to the particular item regarding whether the disclosure is agreed.

This makes it possible to set disclosure agreements and refusals collectively for a particular item for the service Si and other items highly related to the particular item regarding whether to agree with the disclosure, by carrying out a single setting operation, which results in a reduction in the number of items to be checked in the setting operation and accordingly a reduction in the work for the setting operation.

The information processing apparatus 101 is able to select some of the items for the service Si highly related to other items regarding whether the disclosure is agreed based on the relations determined as the result, and create a template in which a disclosure agreement or refusal of each of the selected items is set in advance.

In this way, it is possible to create the template in which items each highly related to another item regarding whether the disclosure is agreed are picked out among the items for the service Si. For example, for making the settings for information disclosure to the service Si, the user is enabled to efficiently carry out the setting operation by first making the settings for multiple items settable by a single setting operation preferentially, and then by making the settings for the remaining unset items individually.

Moreover, the information processing apparatus 101 is able to judge whether the target user has completed the settings for information disclosure to the service Si, and create the template and the additional information for service Si when the target user has not completed the settings for information disclosure to the service Si. This stops redundant creation of the template and the additional information for the service Si to which the target user has completed the settings for information disclosure.

With the advantages described above, the information processing apparatus 101 enables a user who desires to use a service Si provided by an information user to easily carry out the operation of setting disclosure agreements and refusals of personal information (personal data), which makes it possible to promote use and application of the service Si.

The disclosure information setting method described in the embodiment may be implemented by executing a program prepared in advance on a computer such as a personal computer or a workstation. The program may be divided into one or more programs. The disclosure information setting program may be recorded on a computer-readable recording medium such as a hard disk, a flexible disk, a compact disc read-only memory (CD-ROM), a magneto-optical disk (MO), a digital versatile disc (DVD), or Universal Serial Bus (USB) and may be executed by a computer after being read from the recording medium. Also, the disclosure information setting program may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information setting apparatus comprising:
a memory; and
a processor, coupled to the memory, configured to:
create a template and assistance information based on setting information indicating disclosure agreements and refusals of each item set by other users who have completed settings for information disclosure to a first service, the template having a disclosure agreement or refusal of each of items for the first service set in advance, the assistance information giving assistance for selecting a disclosure agreement or refusal of each of the items, and
output the created template and the created assistance information.

2. The information setting apparatus of claim 1, wherein
the assistance information is information indicating a percentage of users who have set a disclosure agreement of the item among the other users who have completed the settings for information disclosure to the first service.

3. The information setting apparatus of claim 2, wherein
the assistance information is information that enables disclosure agreements to be set collectively for items, the percentage of which is equal to or more than a first threshold, among the items for the first service.

4. The information setting apparatus of claim 2, wherein
the assistance information is information that enables disclosure refusals to be set collectively for items, the percentage of which is less than a second threshold, among the items for the first service.

5. The information setting apparatus of claim 2, wherein
the assistance information is information indicating a time-series change in the percentage within a given period.

6. The information setting apparatus of claim 1, wherein
the other users are users of a sex and generation, at least one of which is a same as the first user.

7. The information setting apparatus of claim 1, wherein the processor is configured to
identify other users who have completed settings for information disclosure to all services to which the first user has completed the settings for information disclosure among a plurality of services,
identify a user group which has a setting tendency of information disclosure similar to that of the first user based on setting information indicating disclosure agreements and refusals of each item for the plurality of services set by the first user and the identified other users, and
create the template based on setting information indicating disclosure agreements and refusals of each of the items for the first service set by the users in the identified user group.

8. The information setting apparatus of claim 1, wherein the processor is configured to
identify a user group for each concerned service to which the first user has completed the settings for information disclosure among a plurality of services, the user group having a setting tendency of information disclosure similar to that of the first user based on setting information indicating disclosure agreements and refusals of each item for the concerned service set by users who have completed the settings for information disclosure to the concerned service, and
create the template based on setting information indicating disclosure agreements and refusals of each of the items for the first service set by the users in the identified user group.

9. The information setting apparatus of claim 1, wherein the processor is configured to
based on setting information indicating disclosure agreements and refusals of each item set by users who have completed settings for information disclosure to a plurality of services including the first service, determine a relation between items for the plurality of services regarding whether a disclosure is agreed, and
based on the relations determined as a result, create the assistance information that enables disclosure agreements and refusals to be set collectively for a certain item for the first service, and other items highly related to the certain item regarding whether the disclosure is agreed.

10. The information setting apparatus of claim 9, wherein
the processor is configured to select, from the items for the first service based on the relations determined as the result, an item highly related to another item regarding whether the disclosure is agreed, and creates template in which a disclosure agreement or refusal of each selected item is set in advance.

11. The information setting apparatus of claim 1, wherein the processor is configured to
judge whether the first user has completed the settings for information disclosure to the first service, and
create the template and the assistance information in a case where the first user has not completed the settings for information disclosure to the first service.

12. The information setting apparatus of claim 9, wherein
the processor is configured to create the assistance information indicating a disclosure agreement or refusal of each of a certain item for the first service and other item highly related to the certain item regarding whether the disclosure is agreed based on the relations determined as the result.

13. A non-transitory computer-readable recording medium having stored therein a computer program for causing a processor to execute a process, the process comprising:
creating a template and assistance information based on setting information indicating disclosure agreements and refusals of each item set by other users who have completed settings for information disclosure to a first service, the template having a disclosure agreement or refusal of each of items for the first service set in advance, the assistance information giving assistance for selecting a disclosure agreement or refusal of each of the items, and
outputting the created template and the created assistance information.

14. The non-transitory computer-readable recording medium of claim 13, wherein
the assistance information is information indicating a percentage of users who have set a disclosure agreement of the item among the other users who have completed the settings for information disclosure to the first service.

15. The non-transitory computer-readable recording medium of claim 14, wherein
the assistance information is information that enables disclosure agreements to be set collectively for items, the percentage of which is equal to or more than a first threshold, among the items for the first service.

16. The non-transitory computer-readable recording medium of claim 14, wherein
the assistance information is information that enables disclosure refusals to be set collectively for items, the percentage of which is less than a second threshold, among the items for the first service.

17. The non-transitory computer-readable recording medium of claim 15, wherein
the assistance information is information indicating a time-series change in the percentage within a given period.

18. The non-transitory computer-readable recording medium of claim 13, wherein
the other users are users of a sex and generation, at least one of which is a same as the first user.

19. The non-transitory computer-readable recording medium of claim 13, wherein the process further comprising:
identifying other users who have completed settings for information disclosure to all services to which the first user has completed the settings for information disclosure among a plurality of services,
identifying a user group which has a setting tendency of information disclosure similar to that of the first user based on setting information indicating disclosure agreements and refusals of each item for the plurality of services set by the first user and the identified other users, and
creating the template based on setting information indicating disclosure agreements and refusals of each of the items for the first service set by the users in the identified user group.

20. A computer-implemented setting method comprising:
creating a template and assistance information based on setting information indicating disclosure agreements and refusals of each item set by other users who have completed settings for information disclosure to a first service, the template having a disclosure agreement or refusal of each of items for the first service set in advance, the assistance information giving assistance for selecting a disclosure agreement or refusal of each of the items, and
outputting the created template and the created assistance information.
